(19) United States
(12) Patent Application Publication
(10) Pub. No.: US 2026/0103924 A1
(43) Pub. Date: Apr. 16, 2026

(54) Creating a Virtual Buffer to Avoid Contact Upon Opening a Car Door Based on Predicted Contact

(71) Applicant: Volvo Car Corporation, Göteborg (SE)

(72) Inventors: Jonas Olof Bertil CARLSSON, Mölndal (SE); Mathias Yannick Philippe LE SAUX, Göteborg (SE)

(21) Appl. No.: 18/913,332

(22) Filed: Oct. 11, 2024

(51) Int. Cl. E05C 17/00; B60Q 9/00

(52) U.S. Cl. CPC E05C 17/006; B60Q 9/008

(57) ABSTRACT

An automated vehicle door control system is described that facilitates preventing contact between the door and an external object upon door opening. For example, a vehicle can comprise a memory that stores computer executable components, and a processor that executes the computer executable components stored in the memory, comprise a contact zone component, an object monitoring component and a control component. The contact zone component generates a contact zone surrounding the vehicle wherein the contact zone comprises an area outside the vehicle when doors of the vehicle are fully extended. The object monitoring component that identifies a moving object not within the contract zone that is moving towards the contact zone. The control component determines a point in time when the moving object will enter the contact zone and limits the opening of the vehicle door to reduce the contact zone to avoid collision.

### TECHNICAL FIELD

The disclosed subject matter relates to vehicles (e.g., transportation vehicles) and, more particularly, to an automated vehicle door control system that facilitates preventing contact between one or more doors of the motor vehicle and an external object upon door opening.

### BACKGROUND

Opening car doors and getting dings can be a common issue. In many scenarios, such as crowded parking lots or narrow streets, there may not be enough space between cars to fully open the door without it encountering adjacent vehicles. In addition, people may not pay close attention when opening their car doors, especially if they're in a rush or distracted. This can result in accidentally hitting nearby vehicles or other external objects (e.g., poles, walls, bikes, etc.). The angle at which a car is parked can also affect the likelihood of getting dings. For example, cars parked at an angle may have less clearance space between them, increasing the risk of contact when doors are opened. Other factors such as door design and weather conditions can also influence the likelihood of getting dings. For example, some car doors have a wider swing radius or longer length, making them more prone to hitting nearby objects when opened fully. Windy conditions can also make it more challenging to control the opening of car doors, increasing the likelihood of accidentally hitting neighboring vehicles and other external objects. Limited visibility, such as when parked between larger vehicles or in dimly lit areas, can also make it harder to gauge the distance between cars when opening doors.

The above-described background relating to vehicle doors and issues surrounding getting dings in association with opening vehicle doors is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate controlling the functionality of one or more doors of a vehicle to prevent contact with external objects upon opening are described.

As alluded to above, techniques for preventing or minimizing dings in association with opening vehicle doors are desirable, and various embodiments are described herein to this end and/or other ends.

According to an embodiment, a vehicle, comprises: a processor that executes the computer executable components stored in memory, wherein the computer executable components comprise: a contact zone component that generates a contact zone surrounding the vehicle wherein the contact zone comprises an area outside the vehicle when doors of the vehicle are fully extended; an object monitoring component that identifies a moving object not within the contract zone that is moving towards the contact zone; and a control component that determines a point in time when the moving object will enter the contact zone, and limits opening of a vehicle door to reduce size of the contact zone to mitigate collision between the vehicle door and the moving object.

According to another embodiment, a method for controlling an enclosure of a vehicle, comprises: generating, by a system of the vehicle comprising a processor based on sensory data captured of an external environment of the enclosure via one or more sensors integrated on or within the vehicle, a contact zone surrounding the vehicle wherein the contact zone created outside the vehicle when doors of the vehicle are fully extended; identifying, by the system, a moving object not within the contract zone that is moving towards the contact zone; and determining, by the system, a proximate location of the moving object within the contact zone and creating a contact free zone wherein the opening of the vehicle door will not collide with the moving object.

According to yet another embodiment, a non-transitory machine-readable medium can comprise executable instructions that, when executed by a processor of a vehicle system, facilitate performance of operations, comprising, generating a contact zone surrounding the vehicle wherein the contact zone created outside the vehicle when doors of the vehicle are fully extended, identifying a moving object not within the contract zone that is moving towards the contact zone, and determining proximate location of the moving object within the contact zone and creating a contact free zone wherein the opening of the vehicle door will not collide with the moving object.

### BRIEF DESCRIPTION OF DRAWINGS

FIG. 1 illustrates a block diagram of an exemplary system that facilitates mitigating dings in association with opening vehicle doors, in accordance with one or more embodiments described herein.

FIG. 2 presents a simplified top-down view of a vehicle illustrating example clearance regions of respective passenger doors of the vehicle in accordance with one or more embodiments described herein.

FIG. 3 illustrates an example scenario in which a ding mitigation system of a vehicle can facilitate minimizing dings in association with opening passenger doors of the vehicle, in accordance with one or more embodiments described herein.

FIG. 4 illustrates another example scenario in which a ding mitigation system of a vehicle can facilitate minimizing dings in association with opening passenger doors of the vehicle, in accordance with one or more embodiments described herein.

FIG. 5 presents a simplified left-side view of a vehicle illustrating example clearance regions of the hood and trunk enclosures of the vehicle in accordance with one or more embodiments described herein.

FIG. 6 illustrates an example scenario in which a ding mitigation system of a vehicle can facilitate minimizing dings in association with opening the hood and trunk enclosures of the vehicle, in accordance with one or more embodiments described herein.

FIG. 7 illustrates a block flow diagram of an example, non-limiting computer-implemented method for minimizing dings in association with opening enclosures of a vehicle, in accordance with one or more embodiments described herein.

FIG. 8 illustrates a block flow diagram of another example, non-limiting computer-implemented method for minimizing dings in association with opening enclosures of a vehicle, in accordance with one or more embodiments described herein.

FIG. 9 illustrates a block flow diagram of another example, non-limiting computer-implemented method for minimizing dings in association with opening enclosures of a vehicle, in accordance with one or more embodiments described herein.

FIG. 10 illustrates a block flow diagram of an example, non-limiting computer-implemented method for mitigating contact in association with opening enclosures of a vehicle, in accordance with one or more embodiments described herein.

FIG. 11 illustrates a block flow diagram of another example, non-limiting computer-implemented method for mitigating contact in association with opening enclosures of a vehicle, in accordance with one or more embodiments described herein.

FIG. 12 illustrates a block flow diagram of another example, non-limiting computer-implemented method for mitigating contact in association with opening enclosures of a vehicle, in accordance with one or more embodiments described herein.

FIG. 13 is an example, non-limiting computing environment in which one or more embodiments described herein can be implemented.

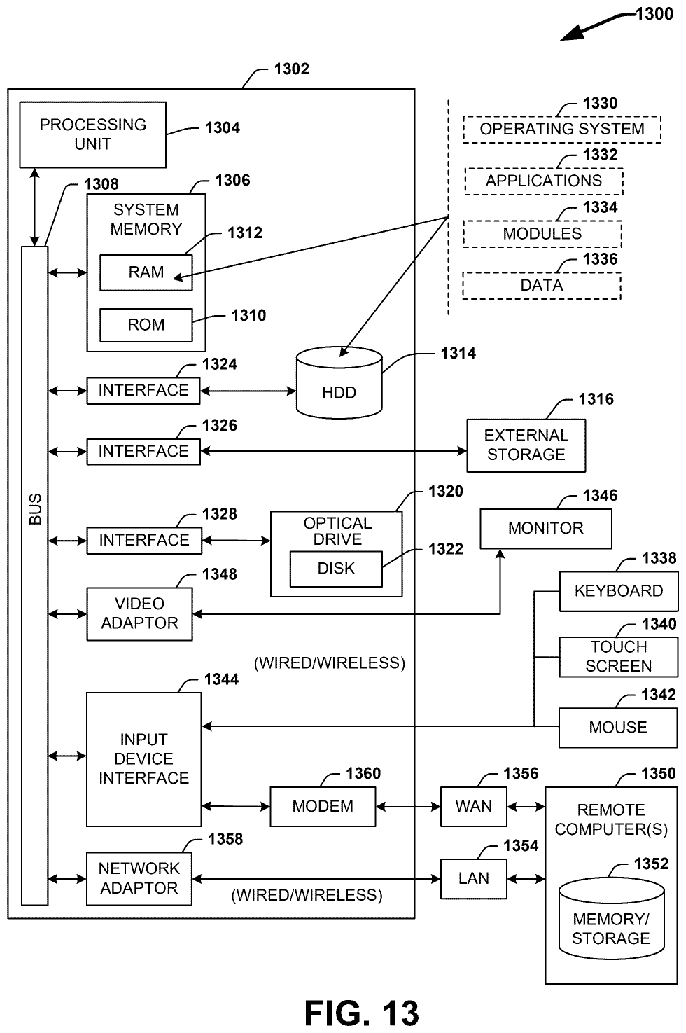

FIG. 14 is an example, non-limiting networking environment in which one or more embodiments described herein can be implemented.

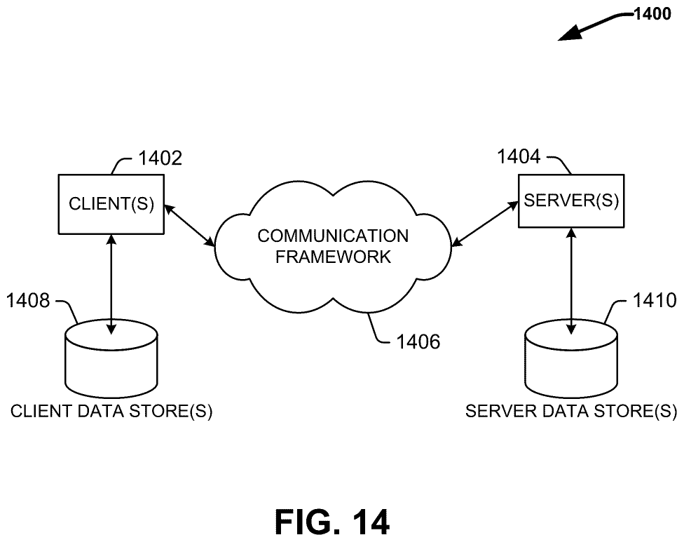

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As alluded to above, techniques for preventing or minimizing dings in association with opening vehicle doors are desirable, and various embodiments are described herein to this end and/or other ends. In accordance with one or more embodiments, the disclosed solution provides a buffer created by sensors and camera of an onboard ding mitigation system of the vehicle that limit the opening of the door. In aspect, the ding mitigation system defines a clearance region for each part or enclosure of the vehicle that can be opened (e.g., doors, hood or truck). When the vehicle is parked or stopped, the ding mitigation system determines if there is an object positioned within the clearance region of an enclosure, and if so, can restrict the functionality of enclosure to avoid making contact with the item.

In an aspect, the ding mitigation system can allow the door to open up to a predetermined distance between the portion of the door that would make the contact and the object. For example, if the edge of the door would make contact with the object (e.g., another car or wall) when opened, the ding mitigation system will not allow the door to open to its full capacity and limit the opening to avoid contacting the object. Where the car is parked in a manner that a portion of the door (e.g., middle of the door) would make a contact, such as parked next to pole, the system would limit the opening of the door in a similar fashion. Thus, according to various aspects, the system would create a gap/buffer between a portion of the door/trunk/hood and an object within the clearance region. For example, the system can limit the opening of the door or provide a resistance few inches away from the contact point.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

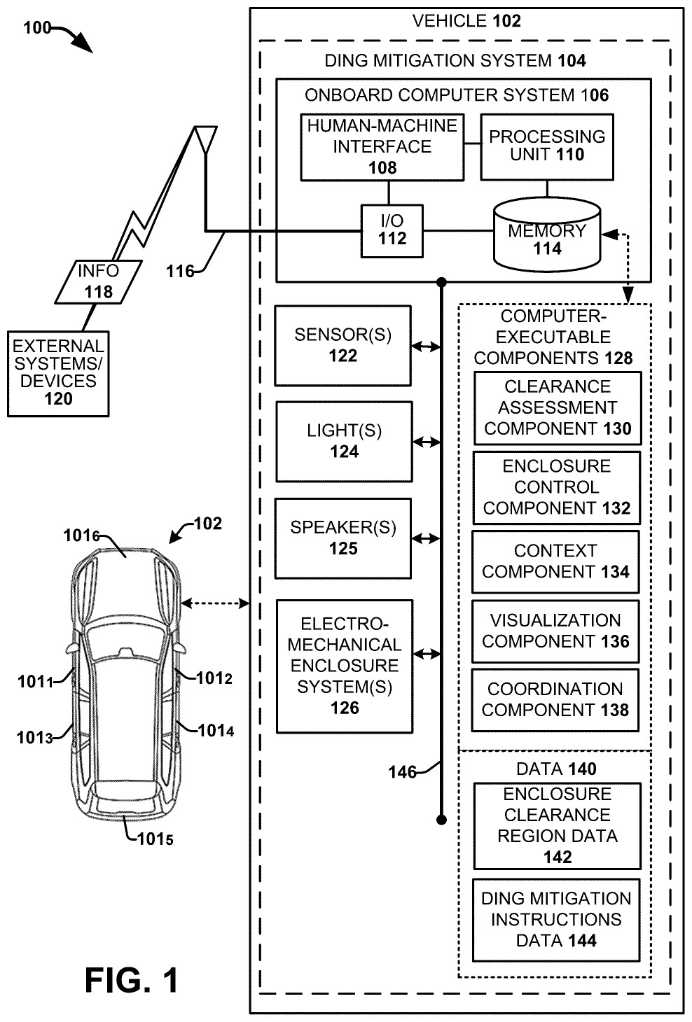

Turning now to the drawings, FIG. 1 illustrates a block diagram of an exemplary system 100 that facilitates mitigating dings in association with opening one or more enclosures of a vehicle 102, in accordance with one or more embodiments described herein. System 100 comprises vehicle 102 with a ding mitigation system 104 located thereon. Vehicle 102 can correspond to any type of vehicle comprising one or more enclosures (e.g., doors, passenger doors, a hood enclosure, a trunk enclosure, etc.) configured to open and close via a mechanical mechanism that can be electrically controlled (e.g., an electromechanical mechanism). To this end, the ding mitigation system 104 can include one or more electromechanical mechanical enclosures systems 126 that are coupled to the one or more enclosures that electrically control opening and/or closing of the respective enclosures based on electrical signals applied to an electromechanical enclosure mechanism employed by the respective enclosures.

For instance, as illustrated in FIG. 1, vehicle 102 corresponds to a car comprising six enclosures 101₁₋₆, including four passenger doors (e.g., frontside left and right driver/passenger doors 101₁ and 101₂, and backside left and right passenger doors 101₃ and 101₄), a hood enclosure 101₆ and a trunk enclosure 101₅. As illustrated in FIG. 1, all of the doors or enclosures of vehicle 102 are illustrated in a closed position. The mechanical or electromechanical mechanism via which the respective enclosures of vehicle 102 are configured to open and close can vary. For example, in some implementations, the mechanical mechanism can include a hinge mechanism that comprises one or more hinges via which one or more of the enclosures are physically attached to a main body or frame of the vehicle 102 and that enable the enclosures to pivot or swing relative to the main body or frame between a fully open position and closed position. Other suitable enclosures and mechanical open/close mechanisms employed by the enclosures are envisioned. As used herein, the terms “fully open,” fully opened,” and variants thereof, as used with respect to the position of an enclosure of vehicle 102 refers to the maximum open position of the enclosure enabled by the mechanical or electromechanical enclosure mechanism used to couple the enclosure to the main body or frame of the vehicle 102. The term “closed” as used with respect to the position of an enclosure of vehicle 102 refers to the position of the enclosure in which the opening of the vehicle that the enclosure is adapted to enclose is entirely enclosed.

In accordance with conventional modern cars, the respective enclosures of vehicle 102 can include or be operatively coupled to an electromechanical locking device via which the enclosures can be locked and unlocked when in the closed position to control opening of the respective enclosures. In some implementations, the one or more electromechanical enclosure systems 126 can electrically control opening of the respective enclosures as a function of electrically locking and unlocking the electromechanical locking devices coupled thereto based on corresponding control signals applied thereto (e.g., via enclosure control component 132).

Additionally, or alternatively, the mechanical mechanism via which the respective enclosures of vehicle 102 move between a closed position and a fully open position can include or correspond to an electromechanical movement mechanism or an electromechanical enclosure device or system that can be electrically controlled by the one or more electromechanical enclosures systems 126 based on electrical signals applied thereto. In this regard, the one or more enclosures or doors of vehicle 102 can include or correspond to automatic doors, and the one electromechanical enclosure systems 126 can include or correspond to an automatic door/enclosure system coupled to the automatic doors. Automatic doors on cars are doors that can be opened and closed automatically without the need for manual intervention by the driver or passengers using motors, and/or electrical control systems (e.g., represented or embodied via the one or more electromechanical enclosure systems 126) to facilitate automated operation. For example, the one or more enclosures of the vehicle 102 and the one or more electromechanical enclosure systems 126 operatively coupled thereto can include or correspond to a power sliding door, a power tailgate or power trunk door, a soft-close door, a power assisted door, a gullwing door, or another type of automatic door. For instance, in some implementations in which the enclosures of vehicle 102 respectively employ hinges (and thus correspond to hinge enclosures), the hinges can include or correspond to electromechanical hinges operatively couple to electrical power motors, wherein the position of the hinges (and thus the position of the enclosures relative to the body or main frame of the vehicle 102) can be electrically controlled automatically and moved between a closed position and a fully open position, with varying partially open positions therebetween.

With these embodiments, the one or more electromechanical enclosure systems 126 can electrically control movement of the enclosures between the closed position and the fully open position based on electrically controlling movement of the electrical mechanical hinges via their respective electrical power motors. In this regard, based on electrical signals applied to the electromechanical hinges and/or another type of automatic door opening and closing system employed, the one or more electromechanical enclosure systems 126 can electrically control movement of the enclosures between a closed position, a fully open position and different partially open positions therebetween. In other words, the one or more electromechanical enclosure systems 126 coupled to the respective enclosures can electrically control the degree to which the enclosures are opened or closed relative to the body or main frame of the vehicle 102 (e.g., based on corresponding control signals provided by the enclosure control component 132).

In accordance with various embodiments, the ding mitigation system 104 can automatically (e.g., without manual intervention) electrically control opening of one or more of the enclosures (e.g., enclosure 106₁₋₆ and the like) of vehicle 102 in a manner that involves restricting opening of the enclosures and/or restricting the degree to which the enclosures can be opened or closed relative to the body or main frame of the vehicle 102 to prevent or minimize contact between the enclosures and an external object (e.g., another vehicle, a pole, a bike, an animal, a person, etc.) positioned external to the enclosure. More particularly, the ding mitigation system 104 can detect or determine whether an object external to an enclosure of the vehicle 102 is positioned within a clearance region of the enclosure (e.g., via clearance assessment component 130). The ding mitigation system 104 can further control the opening of the enclosure based on whether the object is positioned within the clearance region. For example, the ding mitigation system 104 can prevent or restrict the opening of the enclosure to prevent or minimize contact between the external surface of the enclosure and the object. For instance, the ding mitigation system 104 can control (e.g., via enclosure control component 132 and the one or more electromechanical enclosure systems 126 operatively connected to the enclosure) opening of the enclosure by controlling locking and unlocking of the enclosure (e.g., locking the enclosure until the object is no longer positioned within the clearance region) and/or by restricting the degree to which the enclosure can be opened (e.g., enabling partial opening of the enclosure) such that the external surface of the enclosure cannot contact the object.

To facilitate this end, the ding mitigation system 104 can employ predefined information known for each of the enclosures of vehicle 102 defining the respective clearance regions of each of the enclosures. This information can be stored in memory 114 (e.g., represented in FIG. 1 as enclosure clearance region data 142) of an onboard computer system 106 of vehicle 102. The clearance region defined for each enclosure of the vehicle 102 corresponds to the amount of space required for the enclosure to move from the closed position to the fully open position without obstruction. The clearance region of each enclosure of the vehicle 102 depends on many factors, including (but not limited to) the type of the enclosure, the mechanical movement mechanism employed, the position of the enclosure at the fully open position, the geometry of the enclosure, the topology of the external surface of the enclosure, the movement path or trajectory of the enclosure as moved from the closed position to the fully open position, and so on. In general, the clearance region of each (or one or more) enclosure of vehicle 102 can be predefined in the clearance region data 142 and corresponds to a maximum volume region defined based on the boundary of the external surface of the enclosure when in its fully opened position and a defined volume region between the boundary and the opening of the vehicle 102 that the enclosure is adapted to enclosed when in the closed position.

As shown in FIG. 1, in some embodiments, in addition to the clearance assessment component 130, enclosure control component 132, the computer-executable components 134 can also include a contact zone component 150, an object monitoring component 152, a control component 154, a sensor system (not shown), an alert component 156 and artificial intelligence component (not shown and referred hereinafter as AI component).

In various embodiments, the contact zone component 150 is configured to generate a contact zone surrounding the vehicle wherein the contact zone comprises an area outside the vehicle when doors of the vehicle are fully extended. In an aspect, the contact zone is defined as area where if an object would collide with the door of the vehicle if fully extended. Contact zone component utilizes the sensor system that provides sensory data to the contact zone component to assist in generating the contract zone, wherein the sensor system comprises one or more cameras and proximity sensors positioned around the vehicle to detect the presence of objects in the contact zone.

In various embodiments, object monitoring component 152 is configured to identify a moving object not within the contract zone that is moving towards the contact zone. In an aspect, the system monitors the surrounding area when the vehicle is slowing down and coming to a stop (e.g., vehicle is being parked). The system monitors all object with trajectory towards the vehicle (e.g., for example a pedestrian walking towards the vehicle or car about to pass the parked vehicle). Object monitoring component 152 utilizes projection and artificial intelligence models to accurately predict all objects will enter the contact zone. In an aspect, the system initiates object monitoring before the car is parked and continuously monitors while the vehicle is stopped. Thus, if the system anticipates that an object surrounding the area is likely to enter the contact zone, it begins to track the object. For example, when the vehicle is entering a parking lot, all the other cars moving are identified as potential objects that could enter the contact zone. Similarly, if the vehicle is parked at the beach where there are multiple objects (e.g., pedestrians, bikers, children, etc.), the system can track the all the objects with a high probability of entering the contact zone.

In various embodiments, the control component 154 determines a point in time when the moving object will enter the contact zone and limits the opening of the vehicle door to reduce the contact zone to avoid collision. The control component 154 is also configured determines a proximate location of the moving object within the contact zone, creates a contact free zone wherein the opening of the vehicle door will not collide with the moving object and restricts the opening of the door to avoid collision with moving object. In some embodiments, the control component 154 provides an increasing resistance force to the vehicle door to prevent further opening to avoid collision if the occupant continues to open the door during the presence of an object. For example, if the occupant ignores the alert and continues to open door, the resistance is increased to slow down the opening of the door. In an aspect, control component 154 determines a proximate location of the moving object within the contact zone, creates a contact free zone wherein the opening of the vehicle door will not collide and provides resistance to the door if occupant attempts to open the door beyond the contact free zone. In various embodiments, when the control component has determined that if opening the door will cause a collision with the identified object, the control component 154 with utilize the alert component 156 that provides an alert to an occupant attempting to open the vehicle door when determined that the moving object will enter the contact zone created by the opening the door. The alert can be in the form of a loud beep, horn or vibration at the door handle. In addition, the alert can be provided externally. If the moving object is pedestrian or any entity that can receive visual or audio signals, the alert component 156 can provide an external alert by activating headlights, taillights, and the horn if determined that moving object will enter the contact zone.

In some embodiments, the AI component can employ various AI and/or machine learning techniques to automatically, learn, generate and adapt this information for respective users of the vehicle based on tracked user activity data for the respective users and other relevant information accessible to the onboard computer system 106 via any suitable wireless communication network (e.g., the Internet) at various relevant data sources. For example, the tracked user activity data can include or correspond to information tracked for one or more authorized users of the vehicle, including their biometric data, their vehicle access activity over time and with respect to various contexts, and the vehicle usage activity over various contexts. The other relevant information sources can include aggregated user activity data for other vehicles under same and disparate contexts, information pertaining to forecasted weather, information pertaining to the current and forecasted environment at the vehicle's current and future location, and other relevant contextual data.

To this end, the AI component can learn the optimal security measures to be applied for respective users under different contexts, the optimal or preferred access permissions and protocols to be applied under different contexts, the optimal or preferred usage permissions to be applied under different contexts and the optimal or preferred user settings with respect to the various features and functionalities of the electronic vehicle systems under different contexts. For example, the AI component can learn, generate and adapt the reference access authorization information for one or more users based on tracked biometric data captured of respective persons corresponding to the one or more defined identities captured via the one or more sensors and using one or more machine learning techniques. In another example, the AI component can learn, generate and adapt, the reference usage authorization information based on tracked usage data regarding historical usage of the one or more operating functionalities of the vehicle by the one or more defined identities and using one or more machine learning techniques.

To facilitate this end, the AI component can employ various types of machine learning techniques for learning explicitly or implicitly how to define projection models that can predict if an object will enter the contact zone. Inferring or learning can employ a probabilistic or statistical-based analysis to infer an action that is to be executed. For example, in some implementations, a support vector machine (SVM) classifier can be employed. Other learning approaches that can be employed by the AI component can include usage of neural networks (e.g., including deep neural networks, deep adversarial neural networks, convolutional neural networks, and the like), Bayesian networks, decision trees, a nearest neighbor algorithms, boosting algorithm, gradient boosting algorithms, linear regression algorithms, k-means clustering algorithms, association rules algorithms, q-learning algorithms, temporal difference algorithm, and probabilistic classification models providing different patterns of independence can be employed. Learning as used herein also is inclusive of statistical regression that is utilized to develop models of priority.

As will be readily appreciated from the subject specification, the subject innovation can employ learning classifiers that are explicitly trained (e.g., via a generic training data) as well as implicitly trained (e.g., via observing user behavior, receiving extrinsic information) so that the learning classifier is used to automatically determine according to predetermined criteria which action to take. For example, SVM's can be configured via a learning or training phase within a learning classifier constructor and feature selection module. A learning classifier is a function that maps an input attribute vector, k=(k1, k2, k3, k4, kn), to a confidence that the input belongs to a learning class-that is, f(k)=confidence(class).

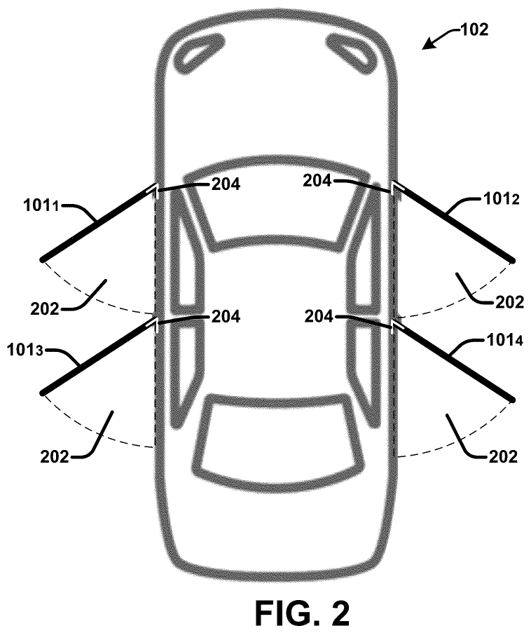

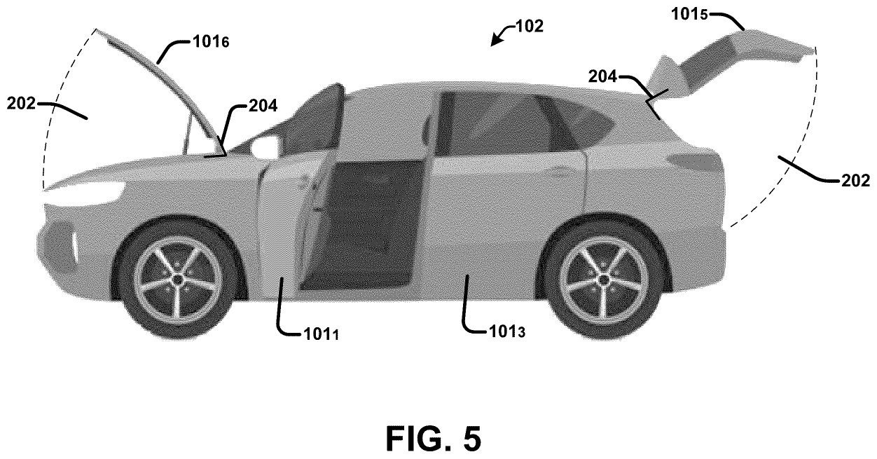

For example, FIG. 2 presents a simplified top-down view of vehicle 102 illustrating example clearance regions 202 of the respective passenger doors (e.g., frontside left and right driver/passenger doors 101₁ and 101₂, and backside left and right passenger doors 101₃ and 101₄), in accordance with one or more embodiments described herein. FIG. 5 presents a simplified left-side view of vehicle 102 illustrating example clearance regions 202 of the hood enclosure 101₆ and the trunk enclosure 101₅ in accordance with one or more embodiments described herein. In FIG. 2 the respective passenger doors 101₁₋₄ are in the fully opened position, and in FIG. 5, the hood enclosure 101₆ and the trunk enclosure 101₅ are in the fully opened position.

In accordance with the examples illustrated in FIGS. 2 and 5, each of the enclosures 101₁₋₆ are physically attached to the body or main frame of the vehicle 102 via one or more hinges 204. In this regard, the respective enclosures pivot, rotate or swing relative to the main body/frame of the vehicle 102 to move between the closed position and the fully opened position via mechanical movement of the respective hinges 204 between a fully closed state in which respective plates of the hinges 204 are parallel or substantially parallel to one another, and a fully open state in which the angle between the respective plates of the hinges 204 are at a defined maximum angle enabled for the hinges 204 (e.g., typically between about 30 degrees and about 150 degrees). In accordance with implementations in which the enclosures employ hinges 204, the clearance regions 204 corresponds to swing clearance regions. Swing clearance refers to the amount of space required for a door or other hinged object to swing open or closed without obstruction. It's the area or volume that needs to be kept clear to accommodate the full range of motion of the door as it moves on its hinges. The amount of swing clearance needed depends on various factors, including the size of the door, the type of hinge used, and the angle at which the door swings. For example, a door with a wider swing angle will require more clearance than one with a narrower swing angle. The swing clearance regions (e.g., clearance regions 202) of the respective enclosures account for the arc of the door as it swings open and any protruding handles or hardware that may extend beyond the door's edge, and the dimensions of the door. In other words, the clearance region 202 or swing clearance region of each of the enclosures 101₁₋₆ corresponds to a predefined geometrical volume region defined based on the maximum angle of the respective hinges 204 when in their fully open state, the dimensions of the respective enclosures, the boundary defined by the external surface or topology (e.g., accounting for any protruding handle surfaces or the like) of the enclosure at its fully opened position, and the fixed swing path or trajectory of the respective enclosures (e.g., as indicated via the dashed semi-circle lines) in association with movement of the respective enclosures between the closed position and the fully open position.

It should be appreciated that although the clearance regions 202 of the enclosures are illustrated as planar or two-dimensional (2D) areas, that the clearance regions 204 respectively correspond to three-dimensional (3D) regions. It should also be appreciated that the clearance regions 202 of the respective enclosures can vary depending on the type of mechanical mechanism via which the respective enclosures move between the closed position in the fully open position, which is not limited to hinges. In addition, it should be appreciated that the clearance regions 202 defined for each of the enclosures 101₁₋₆ (and/or other enclosures of the vehicle 102 or another type of vehicle) and the mechanical movement mechanism employed by each of the enclosures can vary. However, regardless of the type of the enclosure, the mechanical movement mechanism employed, the dimensions of the enclosure, the topology of the external surface of the enclosure, and so on, that the clearance region 202 of each enclosure is predefined (e.g., in memory 114 as clearance region data 142) and corresponds to a maximum volume region defined based on the boundary of the external surface of the enclosure when in its fully opened position and a defined volume region between the boundary and the opening of the vehicle 102 that the enclosure is adapted to enclosed when in the closed position.

With reference again to FIG. 1 in view of FIGS. 2 and 5, to enable automatically controlling the opening of the respective enclosures 101₁₋₆ of vehicle 102 to prevent or minimize contact between the enclosures and external objects, the ding mitigation system 104 can include one or more sensors 122 and an onboard computer system 106 that controls the elector-mechanical enclosure systems 126 coupled to the respective enclosures to control the opening of the respective enclosures based on whether an object external to the enclosures is positioned within or may become position within the clearance region 202 of the respective enclosures at the time of opening thereof. The ding mitigation system 104 can also include one or more lights 124 integrated on or withing the vehicle, and one or more speakers 125 integrated on or within the vehicle. The ding mitigation system 104 can also include a system bus 146 that communicatively and operatively connects the onboard computer system 106, the one or more sensors 122, the one or more lights, the one or more speakers 125 and the one or more electro-mechanical enclosures systems 126 to one another.

In this regard, the one or more sensors 122 can include or correspond to one or more types of sensors integrated on or within the vehicle that facilitate detecting and determining the relative position of an object external to an enclosure of the vehicle 102. For example, the one or more sensors 122 can comprise various types of sensors configured to monitor the external environment of the vehicle 102 and facilitate detecting and determining (e.g., via clearance assessment component 130) the relative position of an object external to an enclosure of the vehicle 102, including detecting whether an object external to an enclosure is positioned within (or likely to be positioned within) the clearance region of the enclosure at the time of opening of the enclosure and the relative position of the object within the clearance region. In some embodiments, the one or more sensors 122 can also facilitate object tracking in association with monitoring and tracking the relative of position of an object with respect to the external body of the vehicle in implementations in which the object moves. The one or more sensors 122 can include any suitable detection/measuring device that facilitates localizing objects and optionally tracking the object's position in implementations in which the object moves. For example, the one or more sensors can include, but are not limited to, including cameras, optical sensors, laser sensors, Light Detection and Ranging (LiDAR) sensors, sonar sensors, audiovisual sensors, perception sensors, motion detectors, velocity sensors, and the like, as employed in such applications as simultaneous localization and mapping (SLAM), and other computer-based technologies and methods utilized to detect and determine information regarding objects (e.g., object type, object geometry, relative position to an enclosure of the vehicle 102, object movement, etc.) external to enclosures of the vehicle 102.

In this regard, sensors are commonly used to localize objects in various applications, such as robotics, autonomous vehicles, and indoor navigation systems. Localization refers to the process of determining the position of an object relative to a known reference point or coordinate system. In accordance with the disclosed techniques, the known reference point can include one or more points of the vehicle, or more particularly one or more points associated with respective enclosures of the vehicle or a coordinate system corresponding to the clearance region of each enclosure. The one or more sensors 122 play a crucial role in this process by collecting sensory data about the object's surroundings which is then used to estimate (e.g., via clearance assessment component 130) the position of the object relative to an enclosure of the vehicle 102 or the clearance region of the enclosure position using various localization and object tracking algorithms (e.g., stored in memory 114 or the like). For example, in some implementations, the one or more sensors 122 can LiDAR sensors which uses laser beams to measure the distance between an object external to an enclosure and one or more points within a coordinate system corresponding to the clearance region of the enclosure. In this regard, by scanning the laser beams across a field of view and measuring the time it takes for the light to reflect to the sensor, the clearance assessment component 130 can create detailed 3D maps of the surroundings of the vehicle. These maps can be used by the clearance assessment component to detect and localize external objects relative to one or more enclosures of vehicle 102. In another example, the one or more sensors can include cameras configured to capture images and/or videos frames of the environment around the vehicle 102 and the clearance assessment component can detect, localize and track objects external to the vehicle using visual odometry and/or SLAM processing techniques. In this regard, visual odometry algorithms analyze images or video frames from cameras to estimate the motion of an object relative to its surroundings. By tracking distinctive features in the environment and comparing their positions between consecutive frames using visual odometry, the clearance assessment component 130 can infer changes in position and orientation. SLAM goes a step further by simultaneously building a map of the environment while localizing the object within that map.

In an example embodiment, the one or more sensors 122 can include separate sensors coupled to each enclosure that provide for detecting and localizing objects external to each enclosure and determining information about the object, including its relative position to the enclosure, object movement and movement path, object type and dimensions, and so on. In another example embodiment, the one or more sensors 122 can include cameras and/or other types of sensors positioned at different locations on or within the vehicle that provide a wider coverage area of the external environment of two or more enclosures (e.g., two or more enclosures located on the same side of the vehicle 102 or the like).

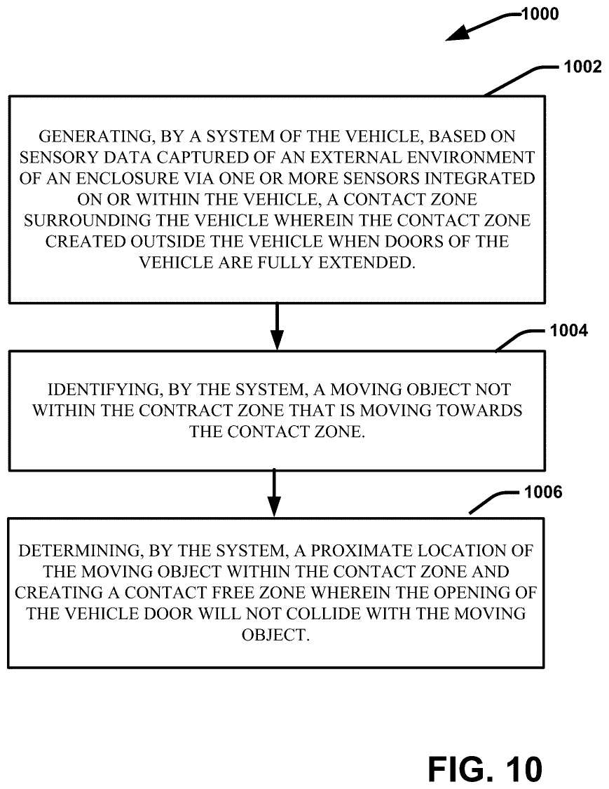

In various embodiments, the memory 114 of the onboard computer system 106 can store computer-executable components 128 that perform operations related to detecting and determining the relative position of objects external to one or more enclosures of the vehicle 102 and mitigating contact between an enclosure and an external object based on whether the object is positioned (or may become positioned) within the clearance region of the enclosure at the time of opening of the enclosure. These computer-executable components 128 can include, but are not limited to, clearance assessment component 130, enclosure control component 132, context component 134, visualization component 136 and coordination component 138. The onboard computer system 106 further includes at least one processing unit 110 that executes the computer-executable components 128. The memory 114 can also store data 140 that is used by the one or more of the computer-executable components 128 to facilitate the corresponding operations described, including (but not limited to) enclosure clearance data 142 and ding mitigation instructions data 144. Examples of said memory 114, processing units 110, and other computer system components that can be included in the onboard computer system 106 to facilitate the various features and functionalities of system 100 can be found with reference to FIG. 10 (e.g., system memory 1010, processing unit 1004, and the like).

As noted above, in various embodiments, the clearance assessment component 130 can determine, based on sensory data captured of an external environment of an enclosure (e.g., any of the enclosures 101₁₋₆ or the like) of the vehicle 102 via the one more sensors 122 integrated on or within the vehicle, whether an object external to the enclosure is positioned within a clearance region (e.g., clearance region 202) of the enclosure prior to opening of the enclosure. The enclosure control component 132 can further control the mechanical or electromechanical movement mechanism of the enclosure to control the opening of the enclosure based on whether the object is positioned within the clearance region to prevent or minimize contact between the external surface of the enclosure and the object.

For example, in some embodiments, prior to opening of an enclosure of the vehicle 102 (e.g., any of the enclosures 101₁₋₆ or the like) the clearance assessment component 130 can determine whether an object external to the enclosure is positioned within the clearance region of the enclosure based on sensory data (e.g., captured via the one or more sensors 122) indicating the relative position of the object to body or main frame of the vehicle 102 and the defined clearance region of the enclosure as provided in the enclosure clearance region data 142). In some implementations, based on a determination that an object is positioned within the clearance region, the enclosure control component 132 can prevent the opening of the enclosure. For example, the enclosure control component 132 can direct (e.g., via wired and/or wireless communication of corresponding control signals) the electromechanical enclosure system 126 coupled to the enclosure to lock the enclosure (e.g., via an electromechanical locking device/mechanism coupled thereto) and thus prevent the opening thereof. The clearance assessment component 130 can further monitor the sensory data captured via the one or more sensors to determine whether and when the object has moved out of the clearance region. Based on a determination that the object is no longer positioned within the clearance region, the enclosure control component 130 can direct (e.g., via wired and/or wireless communication of corresponding control signals) the electromechanical enclosure system 126 coupled to the enclosure to unlock the enclosure (e.g., via an electromechanical locking device/mechanism coupled thereto) and thus enable the opening thereof.

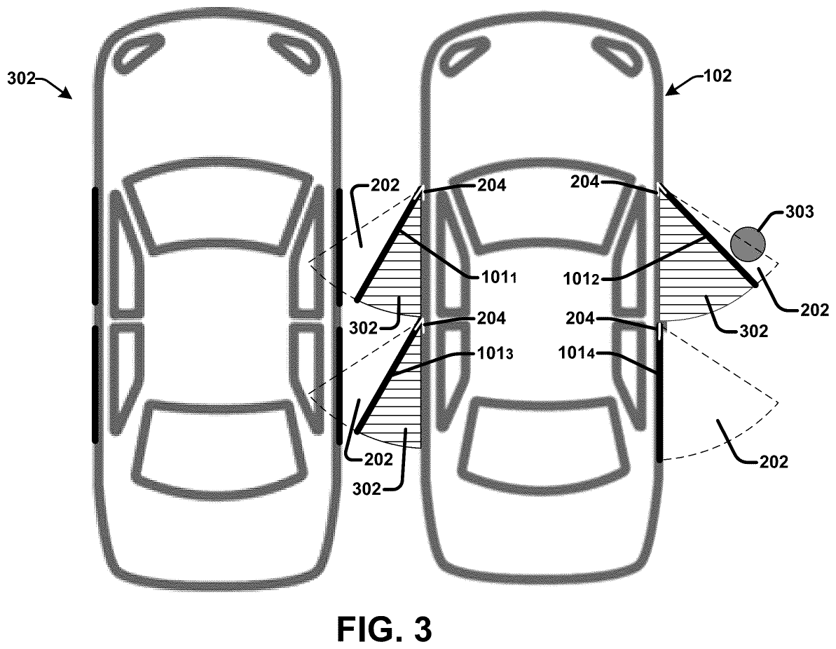

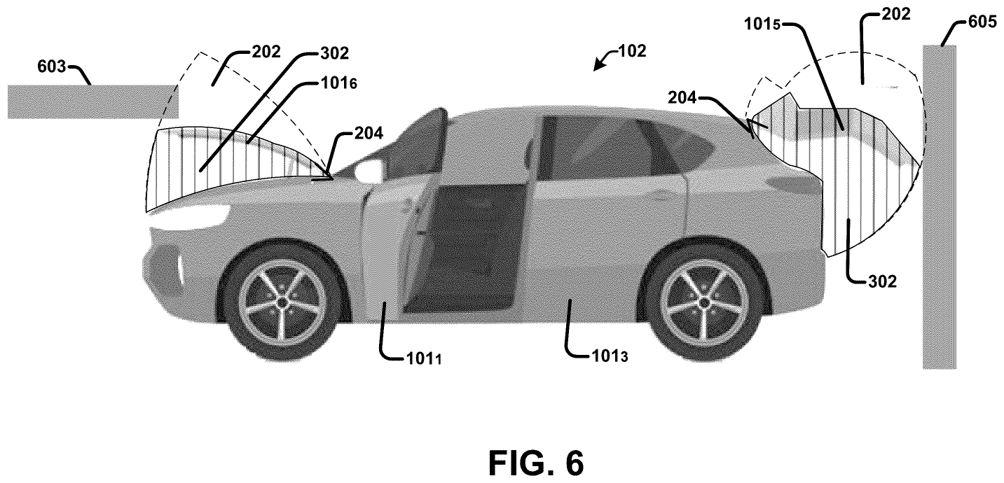

Additionally, or alternatively, prior to opening of an enclosure of the vehicle 102 (e.g., any of the enclosures 101₁₋₆ or the like) and based on sensory data captured via the one or more sensors 122, in association with determining that an object external to the enclosure is positioned within the clearance region, the clearance assessment component 130 can determine the relative position of the object within the clearance region. For example, the clearance assessment component 130 can localize the position of the object within the clearance region using LiDAR technology, visuals odometry, SLAM, or another suitable sensory based object localization technology. With these embodiments, the clearance assessment component 130 can determine a restricted clearance region for the enclosure based on the relative position of the object within the clearance region. The enclosure control component 132 component can further control the opening of the enclosure via the mechanical or electromechanical movement mechanism employed by the enclosure to restrict the opening of the enclosure based on the restricted clearance region. In this regard, the restricted clearance region can comprise a portion of the clearance region defined by a partially opened position of the enclosure that results in the enclosure not contacting the external object as positioned withing the clearance region. The enclosure control component 132 can in turn prevent movement of the enclosure outside of the restricted clearance region so as to prevent contact between the external surface of the enclosure and the object, as illustrated in FIGS. 3 and 6.

For example, FIG. 3 illustrates an example scenario in which the ding mitigation system 104 of vehicle 102 can facilitate minimizing dings in association with opening passenger doors (e.g., enclosures 101₁₋₄) of the vehicle, in accordance with one or more embodiments described herein. FIG. 6 illustrates an example scenario in which the ding mitigation system 104 of vehicle 102 can facilitate minimizing dings in association with opening the hood enclosure 106₆ and the trunk enclosure 106₅ of the vehicle, in accordance with one or more embodiments described herein.

With reference to FIG. 3, in accordance with the example scenario illustrated in FIG. 3, vehicle 102 is parked on the right side of another vehicle 302 with a spacing/distance between the respective vehicles resulting in the right side of vehicle 302 being within the clearance regions 202 of both the left side front and back driver/passenger doors of vehicle 102 (e.g., enclosures 101₁ and 101₃). For example, as shown in FIG. 3, the clearance regions 202 of both the left side front and back driver/passenger doors overlap with or otherwise extend past the external surface of the right side of vehicle 302. Thus, if the left side front and back driver/passenger doors of vehicle 102 (e.g., enclosures 101₁ and 101₃) are enabled to be opened to their fully opened position and the person or persons opening the respective doors do not or cannot (e.g., owing to winding conditions, poor visibility, etc.) manually restrict the degree to which they are opened, the external surfaces of the respective doors can or may hit or otherwise contact and ding or otherwise damage the external surfaces and/or the external surface of the right side of vehicle 302. In addition, an object 303 (e.g., corresponding to a pole or another type of object, person, animal, etc.) is positioned within the clearance region 202 of the front, right-side passenger door (e.g., enclosure 101₂). Thus, if the right front passenger/driver door of vehicle 102 (e.g., enclosures 101₂) is enabled to be opened to its' fully opened position and the person opening the doors does not or cannot (e.g., owing to winding conditions, poor visibility, etc.) manually restrict the degree to which it is opened, the external surface of the door can or may hit or otherwise contact and ding or otherwise damage the external surface of the door and/or the object 303.

Similarly, with reference to FIG. 6, in accordance with the example scenario illustrated in FIG. 6, vehicle 102 is parked with an object 603 (e.g., corresponding to low hanging roof or any other type of object) positioned within the clearance region 202 of the hood enclosure 101₆, and another object 605 (e.g., a wall or any other type of object) positioned within the clearance region 202 of the trunk enclosure 101₅. Thus, if the hood enclosure 101₆ and the trunk enclosure 101₅ are enabled to be opened to their fully opened positions and the person opening the doors does not or cannot (e.g., owing to winding conditions, poor visibility, etc.) manually restrict the degree to which they are opened, the external surfaces of the respective enclosures can or may hit or otherwise contact and ding or otherwise damage the external surfaces of the enclosures and/or the objects 603 and 605 respectively.

With reference to FIGS. 3 and 6 in view of FIG. 1, in accordance with one or more embodiments, prior to opening of the respective enclosures of the vehicle 102 having external objects positioned within their clearance regions 202, based on sensory data captured of the external environment of the vehicle 102, the clearance assessment component 130 can determine that objects are positioned within the clearance regions 202 of respective enclosures (e.g., enclosures 101₁₋₃ in accordance with FIG. 3 and enclosures 101₅₋₆ in accordance with FIG. 6). The clearance assessment component 130 can also determine the relative positions of the objects within the clearance regions 202 of the respective enclosures. The clearance assessment component 130 can further determine a restricted clearance region 302 for each of the enclosures based on the relative positions of the objects within their clearance region 202. In this regard, the restricted clearance region 302 for each of the enclosures corresponds to an amount of space (e.g., 2D region or 3D region) available within the clearance regions 202 for the enclosures to open without the external surfaces thereof contacting the respective objects. In other words, the restricted clearance region 302 for each enclosure corresponds to a partially opened position for each enclosure, wherein the partially opened position does not enable the external surface of the enclosure to contact the object as positioned within its'clearance region 202. For example, in some implementation, the partially opened position can restrict the opening of the enclosure such that when opened to the partially opened position, the external surface of the enclosure is separated from the boundary surface of the object by a defined buffer distance. In accordance with these implementations, the defined buffer distance can be predefined in the ding mitigation instructions data 144. As illustrated in FIGS. 3 and 6, each of the enclosures having external objects positioned within their clearance regions (e.g., enclosures 101₁₋₃ in accordance with FIG. 3 and enclosures 101₅₋₆ in accordance with FIG. 6) are depicted as being opened to such respective partially opened positions (as determined by the clearance assessment component 130).

In accordance with these embodiments, the clearance assessment component 130 can determine the restricted clearance region 303 for each relevant enclosure (e.g., each enclosure having an external object positioned within its'clearance region 202) based on the known or defined spatial geometry of the respective enclosures'clearance regions 202 (e.g., as defined in the enclosure clearance data 142), the relative position of the boundary of the objects within their clearance regions, and the defined buffer distance. Additionally, or alternatively, the clearance assessment component 130 can determine a partially opened position for each enclosure that corresponds to the enclosure being opened to a position within the clearance region 202 with the external surface thereof being separated from the boundary of the object by the defined buffer distance.

Prior to opening of the enclosure (and/or in association with opening of the enclosure) the enclosure control component 132 can further restrict the mechanical or electromechanical opening mechanism of the enclosure such that it cannot be manually opened past the partially opened position. In other words, the enclosure control component 132 can direct the electromechanical enclosure system 126 coupled to the enclosure to prevent or otherwise block the degree to which the enclosure can be manually opened via its corresponding mechanical or electromechanical open/close device/mechanism. For example, in implementations in which the enclosures employ hinges controlled via power motors or the like, the enclosure control component 132 can direct the power motors to enable the hinges to only allow the hinges to open to a restricted angle that results in the respective enclosures being only enabled to be opened to the partially opened position. For instance, the electromechanical enclosure system or systems 126 coupled to the respective power motors can block or restrict the hinges (and thus the corresponding enclosures) from being manually opened or otherwise pushed past the partially opened position without excessive force. Thus, the disclosed ding mitigation system 104 can prevent the relevant enclosures from contacting the external objects when manually opened without consideration or caution of external objects positioned within the clearance regions of the enclosures, and even under windy conditions, dimply lit conditions or other scenarios.

In accordance with the example scenarios illustrated in FIGS. 3 and 6, the ding mitigation system 104 is utilized in association with controlling the opening of one or more enclosures of the vehicle 102 when the vehicle is parked. It should be appreciated that in some scenarios, one or more of the enclosures may be opened when the vehicle 102 is in neutral, stopped or even moving/driving. However, typically enclosures of the vehicle are only opened when vehicle 102 is not moving. Nevertheless, the ding mitigation system 104 can control or otherwise restrict the opening of each (or in some implementations one or more) enclosure of the vehicle based on whether and at what relative position, an external object is positioned within the clearance region of the vehicle, regardless of the operating state of the vehicle 102. To this end, in some embodiments, regardless of the operating state of the vehicle (e.g., parked, in neutral, stopped, driving/moving, etc.) the one or more sensors can continuously or regularly capture sensory data of the external environment of the respective enclosures and the clearance assessment component 130 can continuously (e.g., in real-time) process the sensory data (e.g., using corresponding object detection/localization algorithms) to determine whether an external object is positioned within the clearance region 202 of one or more of the enclosures and the relative position of the object therein prior to opening of the respective enclosures.

Additionally, or alternatively, the clearance assessment component 130 can be configured to assess the external environment of one or more enclosures of vehicle to determine whether an object external to the enclosures is positioned within its'clearance region and determine the relative position of the object within the clearance region based on the context of the vehicle 102 corresponding to a context in which the enclosure is being opened and/or a likely to be opened. With these embodiments, as opposed to continuously maintaining the one or more sensors 122 in an active sensing mode (and thus power consuming state) and continuously processing the sensory data in association with performing object detection and localization, the clearance assessment component 130 can control activation of the one or more sensors 122 and performance of object detection and localization based on the context of the vehicle. In this regard, the clearance assessment component 130 can activate (e.g., via corresponding control signals applied thereto by the clearance assessment component 130 via any suitable wired or wireless communication technology) the one or more sensors 122 and perform object detection and localization relative to one or more enclosures of the vehicle based on the context of the vehicle 102 corresponding to a context in which the one or more enclosures are being opened and/or a likely to be opened. Likewise, the clearance assessment component 130 can deactivate the one or more sensors 122 and refrain from performing object detection and localization based on the context of the vehicle 102 corresponding to another context in which the enclosure is not being opened and/or not likely to be opened (e.g., while the vehicle is moving/driving, when the vehicle is stopped at a traffic light or another stopping scenario during a driving route, when the vehicle is parked and the engine is turned off after occupants have exited the vehicle, and so on). In some implementations of these embodiments, the context component 134 can determine the whether the context of the vehicle corresponds to or does not correspond to a context in which one or more of the enclosures are being opened or likely to be opened, and the clearance assessment component 130 can respond accordingly.

For example, in some implementations, the clearance assessment component 130 can be configured to assess the external environment of one or more enclosure of the vehicle in response to the operating mode of the vehicle transitioning from a driving mode to a parked mode and/or in response to stopping the engine (e.g., assuming under this context the driver and/or one or more passengers are likely to open one or more of the passenger doors). For instance, context component 134 can monitor the operating mode of the vehicle 102 and determine when the vehicle is transitioning to parking and or becomes parked and notify the clearance assessment component 130 accordingly. The context component 134 can also access and utilize navigation information indicating a driving route and arrival at a target destination in association with determining that the context of the vehicle corresponds to a context in which the driver/passengers are likely to open one or more doors of the vehicle to exit the vehicle. The context of the vehicle 102 can also account for the seated position of the occupant or occupants of the vehicle 102 (e.g., as determined by the context component 134 using various mechanisms such as internal sensors coupled to the vehicle seats, internal cameras, or another mechanism) and the known or inferred enclosures that are likely to be opened upon parking the vehicle and stopping the engine. For instance, in some implementations, based on the vehicle only being occupied by the driver, the context component 134 can inform the clearance assessment component 130 that the only the driver door of the vehicle is likely to be opened. According to this example, the clearance assessment component 130 can be configured to only activate a subset of the one or more sensors 122 associated with the driver door to obtain sensory information regarding external objects relative to the driver door (and thus consume power attributed to activating non-relevant sensors) and further only assess external objects relative to the driver door based on the captured sensory data (and thus conserve computational resources (e.g., processing power/speed) involved in the assessment as compared to assessing the external environment around all doors/enclosures of the vehicle).

In another example, the clearance assessment component 130 can account for another context of the vehicle in which the vehicle 102 is being used for a rideshare context or a similar context in which the driver temporarily stops the vehicle to let out one or more passengers. In accordance with this example, context component 134 can determine or infer such a context using various techniques. For instance, the context component 134 can determine that the vehicle is being used for a rideshare context based on utilization of a rideshare application coupled to the onboard computer system 106. In another example as applied to a context in which the driver of the vehicle is merely stopping to let out passengers, the context component 134 can determine what doors are likely to be opened based on analysis of image/video data captured inside the cabin of the vehicle, motion data, or the like, indicating movement of the respective passengers in association with initiating their exist from the vehicle, or the like.

In another example, the context component 134 component can determine what enclosures of the vehicle 102 are being opened or about to be opened based on sensory data (e.g., image data, contact sensor data, etc.) indicating contact between an vehicle occupant and the corresponding internal door handle and/or an external door handle.

The clearance assessment component 130 can similarly tailor activation of the one or more sensors 122 and its assessment of the external environment of one or more enclosures of the vehicle in association with to the context corresponding to a context in which the one or more enclosures are being opened by a person or persons to enter the vehicle or otherwise access the vehicle cabin when located outside the vehicle. For example, in some embodiments in which the vehicle is parked and the engine is turned off, the context component 134 can determine that one or more doors of the vehicle are about to be opened by a person outside the vehicle, based on remotely unlocking of the vehicle. In accordance with these embodiments, in response to detection of this context (e.g., unlocking of the vehicle by an external system/device), the clearance assessment component 130 can activate the one or more sensors 122 and initiate assessing external objects relative to the one or more enclosures of the vehicle accordingly. In another example, in implementations in which the one or more sensors 122 include motion sensors, cameras, or the like, the clearance assessment component 130 can initiate assessment of the external environment of the enclosure based on detection of motion toward the parked vehicle and/or a particular enclosure of the parked vehicle.

In this regard, the context component 134 can determine or infer what enclosures or enclosures of the vehicle are likely to be opened and when, and the clearance assessment component 130 can control the activation of the one or more sensors 122 and tailor its assessment objects external to the corresponding enclosures accordingly.

In some embodiments, to better facilitate assessing the external environment of a vehicle in scenarios in which the external environment is dark (e.g., at night) or dimly lit, the clearance assessment component 130 can also control activation of one or more lights 124 of the vehicle. For example, the vehicle can include one or more lights integrated on or within the vehicle that project light into/toward the clearance regions of the enclosures. With these embodiments, based on the context of the vehicle indicating an enclosure is about to be opened, and based on the environment around the enclosure being dimly lit (e.g., relative to a defined and detectable brightness level), the clearance assessment component 130 can temporarily activate the one or more lights to illuminate the external environment of the vehicle and thereby enable more accurate detection of external objects and their relative positions to the one or more enclosures of the vehicle via the one or more sensors 122 under dimly lit conditions.

Still in other embodiments, the one or more lights 124 can include or correspond to lights integrated on or near the respective enclosures and configured to project an illuminated visualization on the ground outside of the respective enclosures indicating the boundary of the restricted clearance region (e.g., a restricted clearance region 303 applied to an enclosure in association with opening of the enclosure. For example, as applied to one or more of the passenger doors (e.g., enclosures 101₁₋₄), the vehicle 102 can include one or more lights positioned on or within the vehicle relative to the passenger doors (e.g., at the base of the respective doors, under the body of the vehicle and aligned with the respective doors, etc.) configured to project a visual light pattern onto the ground around the passenger doors that outlines or indicates the restricted clearance region, the partially opened position, and/or the clearance region. In some implementations of these embodiments, regardless of detection of an object within the clearance region of an enclosure, the enclosure control component 132 can enable the opening of the door to its fully opened position and the ding mitigation system 104 can provide the light projection on the ground as a visual guide to aid the person opening the door to a partially opened position in which the enclosure does not contact the object.

With these embodiments, the visualization component 136 can control the visual light projection onto the ground via the one or more lights 124 in association with opening the passenger doors. For example, in some implementations, the visual light projection can outline the pattern of the boundary of the restricted clearance region so as to provide a visual guide to the person opening the door as to how far the door can be opened without contacting an external object positioned within the clearance region thereof. In another example, the visual light projection can outline or otherwise indicate the partially opened position at which the door should not be opened past. In some implementations, the visual light projection can employ different colors to indicate when the boundary of the restricted clearance region is reached or nearing being reached as the door is being opened (e.g., a green color can be applied to illuminate the majority of the restricted clearance region and a red color can be applied to illuminate the distal edge or boundary of the restricted clearance region and/or the boundary of the partially opened position). The visualization component 136 can also dynamically change the color of the illuminated projection on the ground as the door is being opened to visually signal when the door has reached the boundary or edge of the restricted clearance region. For example, visualization component 136 can change the color of the projected light pattern from green to red indicate when the boundary of the restricted clearance region has been reached or is nearing being reached as the door is being opened.

Additionally, or alternatively, the enclosure control component 132 employ haptic feedback and/or audio feedback in association with opening one or more enclosures of the vehicle to guide to the person opening the door as to how far the door can be opened without contacting an external object positioned within the clearance region thereof. In some implementations of these embodiments, regardless of detection of an object within the clearance region of an enclosure, the enclosure control component 132 can enable the opening of the door to its fully opened position and the ding mitigation system 104 can provide the haptic feedback and/or the audio feedback to guide the person opening the door to the determined partially opened position (e.g., as determined by the clearance assessment component 130) in which the enclosure does not contact the object. For example, in some implementations, one or more of the enclosures of vehicle 102 can integrate one or more haptic feedback devices configured to generate a vibration or another form of haptic feedback within the door handle or the door itself. With these implementations, the clearance assessment component 130 can monitor the position of the door as it is being opened and direct the one or more haptic feedback devices to generate a vibration signal or another form of haptic feedback in response to the position of the door nearing or reaching the boundary of the restricted clearance region. Additionally, or alternatively, audio feedback (e.g., an alarm, a noise, or another form of an audible signal emitted by oner or more speaker 125 integrated on or within the vehicle 102 (or another speaker of another device coupled to the vehicle and/or the onboard computer system 106, such as a mobile phone, a wearable device, or the like carried/held by the person opening the door) can similarly be used in in addition to and/or alternative to the haptic feedback. For example, the clearance assessment component 130 can direct one or more speakers 125 of the vehicle 102 to generate an audible signal (e.g., an alarm or another suitable audible signal) in response to detection of the position of the door nearing and/or reaching the partially opened position determined for the door.

Still in other embodiments, the visualization component 136 can generate and render a visualization of the clearance region, the restricted clearance region, the partially opened position for the enclosure, and/or the position of an external object within the clearance region of an enclosure via a display located on or within the vehicle 102 to further provide another type of visual guide indicating when and where an object external to an enclosure is positioned within the clearance region thereof. For example, the visualization component 136 can generate and display such a visualization on the infotainment system of the vehicle prior to opening respective passenger doors (e.g., enclosures 101₁₋₄) of the vehicle in association with exiting the vehicle. With these embodiments, the onboard computer system 106 can include a human-machine interface 108 (e.g., a display, a graphical-user interface (GUI)) which can be configured to present render such a visualization and/or other visual information regarding the clearance region, the restricted clearance region, the partially open position for the enclosure, and/or the position of an external object within the clearance region of an enclosure onboard to facilitate minimizing dings in association with opening the enclosures of the vehicle.

The human-machine interface 108 can also provide for receiving user input of information/settings/etc., regarding preferences of the ding mitigation system 104. In this regard, in various embodiments, information controlling the features and functionalities of the clearance assessment component 130 and the enclosure control component 132 can be predefined and stored in memory 114 as ding mitigation data 144. For example, the ding mitigation data 114 can define buffer distances for the respective enclosures, contextual parameters regarding how the clearance assessment component 130 is to operate under varying contexts, (e.g., regarding when to perform activate one or more sensors 122 in association with detecting an localizing objects external to one or more enclosures), control parameters regarding how the enclosure control component 132 is to control the mechanical movement functionality of the one or more enclosures under varying contexts (e.g., locking/unlocking, restricting opening of the enclosures to a partially opened position, the defined buffer distance for each enclosure, etc., enabling/disabling full opening capacity of one or more of the enclosures, etc.), and parameter that control the operations of the visualization component 136 under varying context. For example, in some implementations, based on the context of the vehicle corresponding to an emergency context (e.g., a context involving a vehicular accident or another type of emergency context), regardless of an object being positioned within the clearance region of one or more enclosures of the vehicle, the ding mitigation instructions data 144 can instruct the enclosure control component 132 to enable opening of the one or more enclosures to their full opening capacity.

In some embodiments, the human-machine interface 108 can provide for receiving user input tailoring the ding mitigation instructions based on user preferences. For example, a user may provide input tailoring the ding mitigation instructions to always lock the back passenger doors in response to detection of an external object within the clearance regions of the respective doors are being opening or attempting to be opened. In another example, a user may provide input tailoring the ding mitigation instructions to always lock the back passenger doors in response to detection of an external object within the clearance regions of the respective doors are being opening or attempting to be opened when children (e.g., under a defined age, as determined by the clearance assessment component 130 based on analysis of image data captured of the children or using another suitable technique) are being opening or attempting to be opened. In another example, a user may provide input tailoring the ding mitigation instructions to only restrict the opening of one or more enclosures to the restricted clearance region when the enclosures are being opened from the outside (e.g., to enter the vehicle) as opposed to being opened from the inside (e.g., to exit the vehicle). In another example, a user may provide input tailoring the buffer distance to be applied for one or more of the enclosures. In this regard, the user input can relate to tailoring various features and functionalities of the clearance assessment component 130, the enclosure control component 132 and/or the visualization component 136 in accordance with the various embodiments described herein and based on user preferences.

In some embodiments, the ding mitigation system 104 can also include coordination component 138 to facilitate coordinating opening of enclosures of two or more vehicles 102 in scenarios in which the two or more vehicles are positioned adjacent to one another and wherein each of the vehicles comprise a ding mitigation system 104.

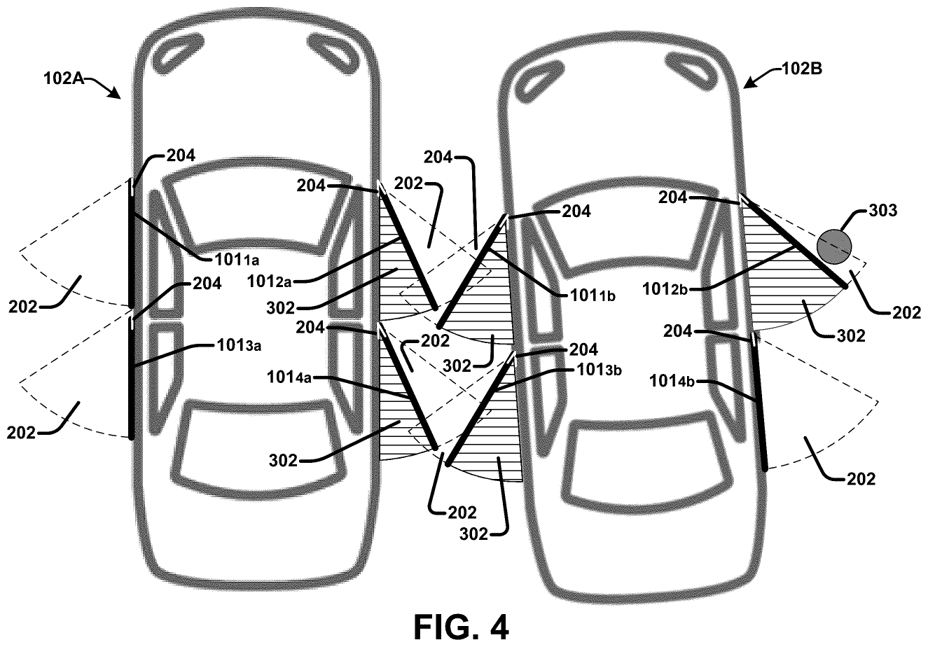

In this regard, FIG. 4 illustrates another example scenario in which the ding mitigation systems 104 of one or more vehicles can facilitate minimizing dings in association with opening passenger doors of the vehicle, in accordance with one or more embodiments described herein. In accordance with the example scenario illustrated in FIG. 4, two vehicles respectively corresponding to vehicle 102 are parked adjacent to one another, respectively indicated as vehicle 102A and vehicle 102B. In this regard, both vehicle 102A and vehicle 102B comprise ding mitigation systems corresponding to ding mitigation system 104. As shown in FIG. 4 the distance between the right side body of vehicle 102A and the left side body of vehicle 102A is such that the clearance regions 202 of the front right side door 101₂ₐ of vehicle 102A and the front left side door 101_{1b} of vehicle 102B overlap and the clearance regions 202, and such that the back right side door 101₄ₐ of vehicle 102A and back left side door 101_{3b} of vehicle 102B overlap. Thus, if both the front right side door 101₂ₐ of vehicle 102A and the front left side door 101_{1b} of vehicle 102B are enabled to be opened to their fully opening capacity and are opened simultaneously without caution, the respective doors can hit and ding one another, (as also applicable to simultaneous opening of the back right side door 101₄ₐ of vehicle 102A and back left side door 101_{3b} of vehicle 102B).

With reference to FIGS. 1 and 4, in some embodiments involving scenarios such as that illustrated in FIG. 5, the ding mitigation system 104 of one or more both vehicles 102A and 102B can monitor the external environment of the respective doors in association with assessing (e.g., via clearance assessment component 130) whether and at what position an external object becomes positioned within the clearance region of the respective doors. To this end, such monitoring can be performed prior to opening of the respective enclosures and during opening of the respective enclosures. In this regard, as a door is being opened, such as enclosure 101_{3b} of vehicle 102B, the clearance assessment component 130 of the ding mitigation system 104 of vehicle 102B can detect (e.g., based on sensory data captured via the one or more sensors 120) if and when an external object, such as an opened door of an adjacent vehicle, becomes positioned within the clearance region of the door. In some implementations of these embodiments, in response to detection of the of an external object within the clearance region of the door as it is being opened, the enclosure control component 132 can stop the door from being opened any further. In addition, in scenarios such as that illustrated in FIG. 4, in which two adjacent doors with overlapping clearance regions are opened simultaneously and in which both vehicles comprise ding mitigation systems 104, the enclosure control component 132 of the other vehicle 102A can also determine if and when an external object (e.g., an opened door of an adjacent vehicle) becomes positioned within the clearance region of a door being opened, such as door 101₄ₐ, and respond the same way. For example, in response to detection (e.g., by the ding mitigation system 104 of vehicle 101B) of door 101₄ₐ becoming within the clearance region 202 of door 101_{3b} as door 101_{3b} is being opened, the enclosure control component 130 of vehicle 101B can block the door 101_{3b} from being opened any further (e.g., via blocking or preventing further movement of the door 101_{3b} about its hinges 204). Likewise, in response to detection (e.g., by the ding mitigation system 104 of vehicle 101A) of door 101_{b3} becoming within the clearance region 202 of door 101₄ₐ as door 101₄ₐ is being opened, the enclosure control component 130 of vehicle 101A can block the door 101₄ₐ from being opened any further (e.g., via blocking or preventing further movement of the door 101₄ₐ about its hinges 204). In this manner, the respective ding mitigation systems of each vehicle can prevent the adjacent doors from hitting one another when being opened at the same time.

Additionally, or alternatively, the coordination component 138 of each ding mitigation system employed by the respective vehicles can coordinate opening and/or controlling opening of adjacent doors of different vehicles in accordance with a defined coordination protocol in scenarios in which the clearance regions of the adjacent doors overlap and in which both doors may be opened simultaneously and/or are likely to be opened simultaneously (e.g., as determined via their respective context components 134). For example, in some embodiments in accordance with the defined coordination protocol, the coordination components 138 of the respective vehicles can coordinate first enabling an adjacent door of one vehicle (e.g., door 101_{3b} of vehicle 102B) to be opened to its allowable capacity given the closed position of the adjacent door (e.g., door 101₄ₐ) of the adjacent vehicle 101A (e.g., which as shown in FIG. 5 corresponds to the fully opened position for door 101_{3b} of vehicle 102B), and once closed, enabling the adjacent door (e.g., door 101₄ₐ) of the other vehicle 101A to be opened to its allowable capacity given the closed position of the adjacent door (e.g., door 101_{3b}) of the other vehicle 101B (e.g., which as shown in FIG. 5 corresponds to the fully opened position for door 101_{3b} of vehicle 102B). In another example, in accordance with another defined coordination protocol, the coordination components 138 of the respective vehicles can coordinate enabling the adjacent doors to be opened simultaneously to partially opened positions that respectively result in both adjacent doors not contacting one another. Various other coordination protocols are envisioned.

To facilitate this end, the ding mitigation systems 104 of the adjacent vehicles (e.g., vehicle 101A and vehicle 101B, or other scenarios involving two or more adjacent vehicles) can be configured to communicate coordination information between one another using any suitable wirelesses technology. In this regard, as shown in FIG. 1, in one or more embodiments, the onboard computer system 106 of ding mitigation system 104 can include an input/output (I/O) component 112, wherein the I/O component 112 can be a transceiver configured to enable transmission/receipt of information 118 between the onboard computer system 106 and any external systems or devices(s). In accordance with the disclosed coordination techniques, the external systems/devices 120 can include or correspond to other vehicles corresponding to vehicles 102, or more particularly, respective ding mitigation systems 104 of the other vehicles. The I/O component 112 can be communicatively coupled, via an antenna 116, to the remotely located devices and systems (e.g., external systems/devices 120). Any suitable technology can be utilized to enable the various embodiments presented herein, regarding transmission and receiving of information 118 between different systems (e.g., different ding mitigation systems 104 of adjacent vehicles or the like). Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

In this regard, the information 118 communicated between adjacent vehicles in association with coordinating opening of doors of adjacent vehicles that have overlapping clearance regions can vary depending on the coordination protocol employed by the respective coordination components 138. For example, the information 118 can include but is not limited to, context information regarding when and whether the adjacent door of each vehicle is expected to be opened (e.g., as determined via respective context components 138 of each vehicle), information defining the clearance regions 202 of the respective doors, information defining restricted clearance regions applicable for the adjacent doors, and/or information defining partially opened positions applicable to the respective doors. In this regard, in some embodiments, based on detection (e.g., via clearance assessment component 130), by a first ding mitigation system of a first vehicle (e.g., vehicle 101A), of a second vehicle parked adjacent to the first vehicle comprising a second ding mitigation system, the coordination component 138 of the first ding mitigation system can communicate coordination information (e.g., via IO component 112 and antenna 116) to the second ding mitigation system. For example, such coordination information can include information defining the clearance regions of one or more first doors of the first vehicle that are adjacent to the second vehicle. Such coordination information can also include context information indicating when and/or whether one or more first doors are likely to be opened. Likewise, the second vehicle can be configured to communicate same or similar coordination information back to the first vehicle. In some implementations of these embodiments, based on the coordination information communicated between the respective vehicles, the coordination component 138 of each vehicle can coordinate controlling opening of the respective adjacent doors. For example, based on the communicated coordination information, one or both vehicles can determine (e.g., via clearance assessment component 130) whether a simultaneous opening of the adjacent doors of the respective vehicles would result in contact between the adjacent doors. Based on a determination that the simultaneous opening would result in contact, the coordination component 138 of one or both vehicles can execute a defined coordination protocol to prevent the simultaneous opening of the respective adjacent doors and/or restrict the opening of the respective doors when being simultaneously opened. In various embodiments, depending on the coordination protocol employed, this can involve communicating additional information between the respective vehicles. For example, in an implementation which the coordination protocol involves allowing the doors of one of the vehicles to be opened and closed first and thereafter allowing the adjacent doors of the second vehicle to be opened, the additional information can include control instructions determined by one or both of the coordination component 138 regarding the order of opening of the respective vehicle doors.

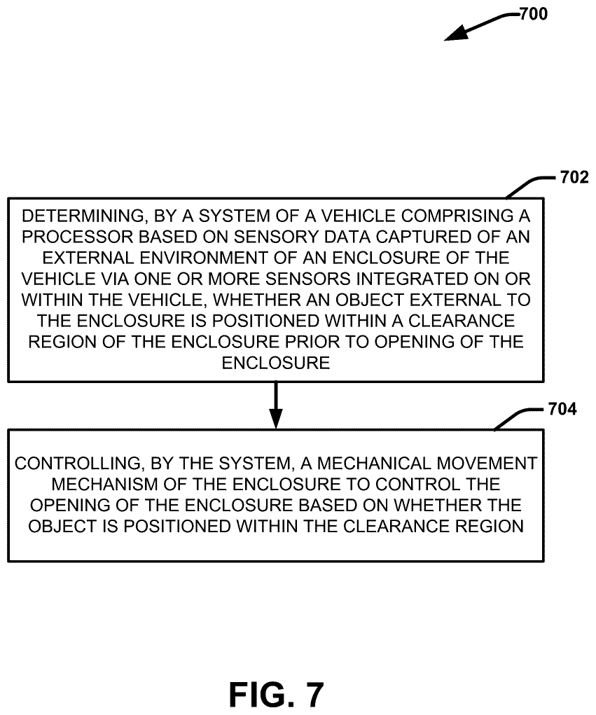

FIG. 7 illustrates a block flow diagram of an example, non-limiting computer-implemented method 700 for minimizing dings in association with opening enclosures of a vehicle, in accordance with one or more embodiments described herein. Method 700 comprises, at 702, determining (e.g., via clearance assessment component 130), by a system (e.g., ding mitigation system 104) of the vehicle (e.g., vehicle 102) comprising a processor based on sensory data captured of an external environment of the enclosure via one or more sensors (e.g., one or more sensors 122) integrated on or within the vehicle, whether an object external to the enclosure is positioned within a clearance region of the enclosure prior to opening of the enclosure. At 702, method system comprises controlling, by the system (e.g., via enclosure control component 132 and one or more electromechanical enclosure systems 126 coupled to the enclosure), a mechanical movement mechanism of the enclosure to control the opening of the enclosure based on whether the object is positioned within the clearance region.

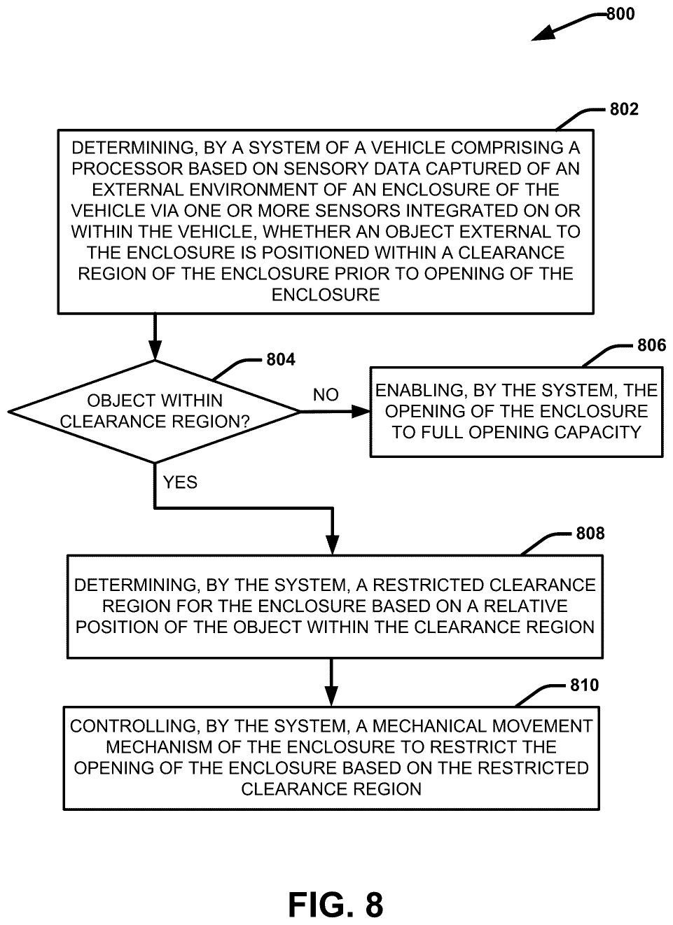

FIG. 8 illustrates a block flow diagram of another example, non-limiting computer-implemented method 800 for minimizing dings in association with opening enclosures of a vehicle, in accordance with one or more embodiments described herein. Method 800 comprises, at 802, determining (e.g., via clearance assessment component 130), by a system (e.g., ding mitigation system 104) of the vehicle (e.g., vehicle 102) comprising a processor based on sensory data captured of an external environment of the enclosure via one or more sensors (e.g., one or more sensors 122) integrated on or within the vehicle, whether an object external to the enclosure is positioned within a clearance region of the enclosure prior to opening of the enclosure. If at 804 the clearance assessment component 130 determines that no object external to the enclosure is positioned within the clearance region, the method 800 continues to 806, wherein the system enables (e.g., via enclosure control component 132 and one or more electromechanical enclosure systems coupled to the enclosure), the opening of the enclosure to full opening capacity.

However, if at 804 the clearance assessment component 130 determines that an object external to the enclosure is positioned within the clearance region, the method 800 continues to 808, wherein the system determines a restricted clearance region for the enclosure based on a relative position of the object within the clearance region (e.g., via clearance assessment component 130). Then at 810, the system controls a mechanical movement mechanism of the enclosure to restrict the opening of the enclosure based on the restricted clearance regions (e.g., via enclosure control component 132 and one or more electromechanical enclosure systems 126 coupled to the enclosure).

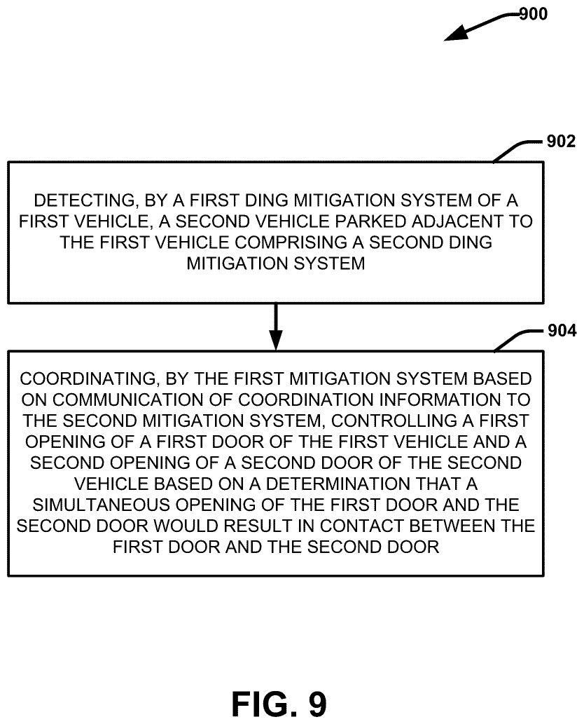

FIG. 9 illustrates a block flow diagram of another example, non-limiting computer-implemented method 900 for minimizing dings in association with opening enclosures of a vehicle, in accordance with one or more embodiments described herein. Method 900 comprises, at 902, detecting, by a first ding mitigation system of a first vehicle, a second vehicle parked adjacent to the first vehicle comprising a second ding mitigation system. For example, the in various embodiments involving coordination between two or more vehicles respectively comprising ding mitigation systems 104, the respective ding mitigation systems can broadcast a signal that can be detected by other ding mitigation systems, wherein the signal identifies the vehicle from which it was emitted and indicates presence of an active ding mitigation system on the vehicle. In this manner the ding mitigation system of the first vehicle can detect presence of an active ding mitigation system on an adjacent vehicle based on reception of the broadcast signal. At 904, method 900 comprises coordinating (e.g., via coordination component 138), by the first mitigation system based on communication of coordination information to the second mitigation system, controlling a first opening of a first door of the first vehicle and a second opening of a second door of the second vehicle based on a determination that a simultaneous opening of the first door and the second door would result in contact between the first door and the second door.

FIG. 10 illustrates a block flow diagram of another example, non-limiting computer-implemented method X00 for controlling opening of doors of vehicle, in accordance with one or more embodiments described herein. As an example, method 1000 can be executed by an electronic computer unit of a vehicle. Method 1000 comprises, at 1002, generating, by a system (e.g., the contact zone component 150) of the vehicle comprising a processor based on sensory data captured of an external environment of the enclosure via one or more sensors integrated on or within the vehicle, a contact zone surrounding the vehicle wherein the contact zone created outside the vehicle when doors of the vehicle are fully extended. At 1004, the method comprises identifying, by the system (object monitoring component 152), a moving object not within the contract zone that is moving towards the contact zone. At 1006, the method comprises determining, by the system (control component 154), a proximate location of the moving object within the contact zone and creating a contact free zone wherein the opening of the vehicle door will not collide with the moving object.

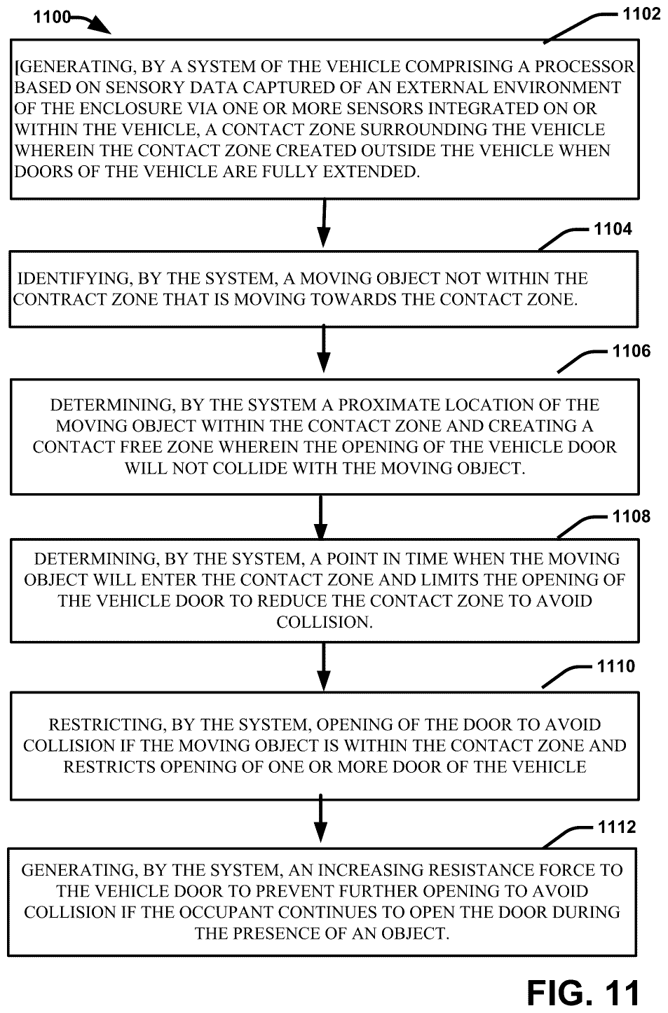

FIG. 11 illustrates a block flow diagram of another example, non-limiting computer-implemented method 1100 for controlling opening of doors of vehicle, in accordance with one or more embodiments described herein. As an example, method 1100 can be executed by an electronic computer unit of a vehicle. Method 1100 comprises, at 1102, generating, by a system (e.g., the contact zone component 150) of the vehicle comprising a processor based on sensory data captured of an external environment of the enclosure via one or more sensors integrated on or within the vehicle, a contact zone surrounding the vehicle wherein the contact zone created outside the vehicle when doors of the vehicle are fully extended. At 1104, the method comprises identifying, by the system (object monitoring component 152), a moving object not within the contract zone that is moving towards the contact zone. At 1106, the method comprises determining, by the system (control component 154), a proximate location of the moving object within the contact zone and creating a contact free zone wherein the opening of the vehicle door will not collide with the moving object. At 1108, the method comprises determining, by the system, a point in time when the moving object will enter the contact zone and limits the opening of the vehicle door to reduce the contact zone to avoid collision. At 1110, the method comprises restricting, by the system, opening of the door to avoid collision if the moving object is within the contact zone and restricts opening of one or more door of the vehicle. At 1112, the method further comprises generating, by the system, an increasing resistance force to the vehicle door to prevent further opening to avoid collision if the occupant continues to open the door during the presence of an object.

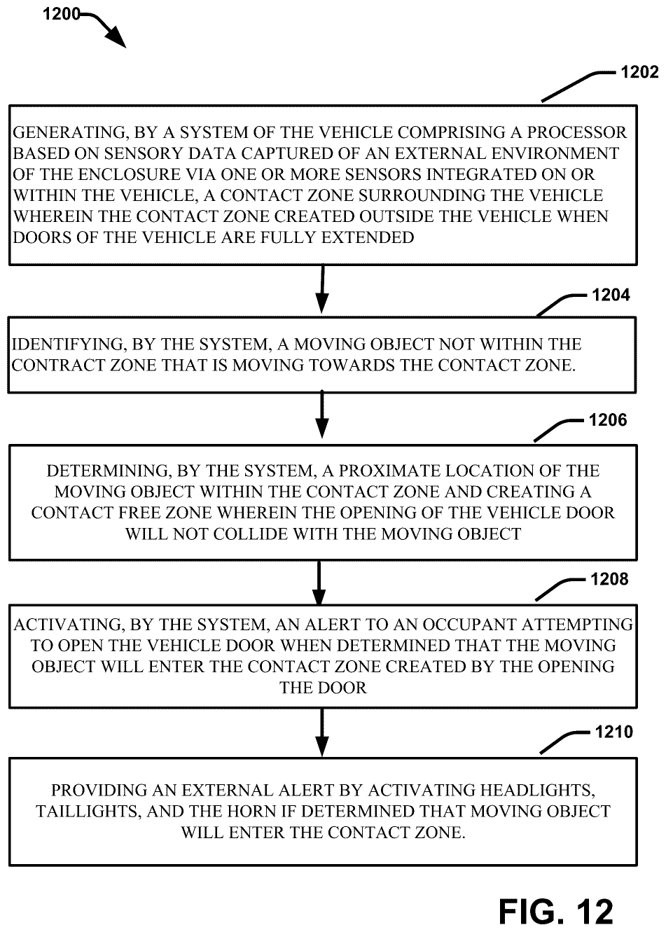

FIG. 12 illustrates a block flow diagram of another example, non-limiting computer-implemented method 1200 for controlling opening of doors of vehicle, in accordance with one or more embodiments described herein. As an example, method 1200 can be executed by an electronic computer unit of a vehicle. Method 1200 comprises, at 1202, generating, by a system (e.g., the contact zone component 150) of the vehicle comprising a processor based on sensory data captured of an external environment of the enclosure via one or more sensors integrated on or within the vehicle, a contact zone surrounding the vehicle wherein the contact zone created outside the vehicle when doors of the vehicle are fully extended. At 1204, the method comprises identifying, by the system (object monitoring component 152), a moving object not within the contract zone that is moving towards the contact zone. At 1206, the method comprises determining, by the system (control component 154), a proximate location of the moving object within the contact zone and creating a contact free zone wherein the opening of the vehicle door will not collide with the moving object. At 1208, the method comprises activating, by the system (e.g., alert component 156) an alert to an occupant attempting to open the vehicle door when determined that the moving object will enter the contact zone created by the opening the door. At 1210, the method comprises providing an external alert by activating headlights, taillights, and the horn if determined that moving object will enter the contact zone.

In accordance with one or more embodiments, the system can utilize cameras, sensors (e.g., proximity sensors, radar, Lidar, etc.) to infer an entity (e.g., other vehicle, pedestrian, cyclist, animal, shopping cart, equipment, etc.) approaching the contact zone. The system can calculate time to entering the contact zone, and take action (e.g., restrict vehicle door movement, notify driver or passenger of the vehicle, notify approaching entity (e.g., via horn, flashing lights, etc.), and based on inferred or determined velocity as well as trajectory, take remedial action to mitigate contact by the vehicle door with the approaching entity.

In accordance with one or more embodiments, the system can take other actions such as locking doors and/or sounding a horn, flashing lights if an approaching entity is inferred to be a risk to individuals within the vehicle. For example, if an approaching entity has a mask and a gun, the system can make an inference that the approaching entity may be a criminal attempting a car-jacking, and the system can take certain actions (e.g., drive away, notify the driver or passengers, sound alarms, lock doors, etc.) to keep the driver or passenger safe.

Various types of machine learning methods can be used for this application in accordance with one or more embodiments described herein. Machine learning is a subset of artificial intelligence (AI) that focuses on the development of algorithms and statistical models that enable computers to learn and make predictions or decisions based on data without being explicitly programmed to do so. In essence, machine learning algorithms learn from patterns and relationships within the data to improve performance over time. For embodiments described herein there are many options such as DNN (Deep neural networks). Deep neural networks (DNNs) are a class of artificial neural networks that are specifically designed to handle complex and high-dimensional data. They are a form of machine learning algorithms that have significantly advanced the field of artificial intelligence (AI) in recent years.

Machine learning can be broadly categorized into three main types based on the learning approach used: supervised learning, unsupervised learning, and reinforcement learning. These three types of machine learning represent different approaches to learning from data and solving various types of problems. Many real-world applications may involve a combination of these approaches or use techniques from one type to complement those of another.

In supervised learning, the algorithm is trained on a labeled dataset, where each input data point is associated with a corresponding target or label. The goal of supervised learning is to learn mapping from input features to output labels, based on the patterns and relationships present in the labeled training data. Supervised learning tasks include classification, where the goal is to predict a categorical label for each input data point, and regression, where the goal is to predict a continuous value for each input data point. Common algorithms used in supervised learning include linear regression, logistic regression, decision trees, random forests, support vector machines (SVM), and neural networks.

In unsupervised learning, the algorithm is trained on an unlabeled dataset, where no explicit labels or targets are provided. The goal of unsupervised learning is to discover patterns, relationships, and structure within the data without the guidance of labeled examples. Unsupervised learning tasks include clustering, where the goal is to partition the data into groups or clusters based on similarity, and dimensionality reduction, where the goal is to reduce the number of features in the data while preserving important information. Common algorithms used in unsupervised learning include k-means clustering, hierarchical clustering, principal component analysis (PCA), and autoencoders.

In reinforcement learning, the algorithm learns through interaction with an environment by taking actions and receiving feedback in the form of rewards or penalties. The goal of reinforcement learning is to learn a policy or strategy that maximizes cumulative rewards over time by exploring different actions and learning from their outcomes. Reinforcement learning tasks include learning to play games, robotic control, autonomous driving, and optimizing business processes. Common algorithms used in reinforcement learning include Q-learning, deep Q-networks (DQN), policy gradient methods, and actor-critic methods. For this innovation, re-enforcement training to train the model for self-correction is a significant aspect.

The choice of machine learning model depends on various factors, including the nature of the data, the task at hand, computational resources, and interpretability requirements. However, some machine learning models are commonly used across different applications due to their versatility and effectiveness. Examples of commonly used machine learning models include linear regression, logistic regression, decision trees, random forests, support vector machines, K-nearest neighbors, and neural networks.

Linear regression is a simple, yet powerful model used for predicting a continuous target variable based on one or more input features. It assumes a linear relationship between the input features and the target variable and seeks to find the best-fitting line or hyperplane that minimizes the difference between the predicted and actual values.

Logistic regression is a binary classification model used for predicting the probability that an input belongs to a particular class. It models the relationship between the input features and the binary outcome using the logistic function, which maps the input values to probabilities between 0 and 1.

Decision trees are versatile models used for both classification and regression tasks. They partition the feature space into a series of hierarchical decisions based on the values of input features, leading to a prediction at the leaf nodes of the tree.

Random forests are an ensemble learning method that combines multiple decision trees to improve predictive performance and reduce overfitting. They build multiple decision trees on bootstrapped samples of the training data and aggregate their predictions to make more robust predictions.

Support vector machines are powerful models used for classification and regression tasks. They find the optimal hyperplane that separates the data into different classes or predicts continuous values, while maximizing the margin between the classes.

K-nearest neighbors is a simple and intuitive model used for classification and regression tasks. It makes predictions by finding the majority class or averaging the values of the k nearest data points in the feature space.

Neural networks are highly flexible models inspired by the structure and function of the human brain. They consist of interconnected layers of neurons that learn complex patterns and relationships in the data through a process called backpropagation.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 110 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

To provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors, field-programmable gate array, AI accelerator application-specific integrated circuit, or other suitable processors. Dual microprocessors and other multi-processor architectures can also be employed as processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include high-speed RAM such as static RAM for caching data. It is noted that unified Extensible Firmware Interface(s) can be utilized herein.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a disc 1022 such as a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 13104 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the. NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 13104 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Referring now to FIG. 11, there is illustrated a schematic block diagram of a computing environment 1100 in accordance with this specification. The system 1100 includes one or more client(s) 1102, (e.g., computers, smart phones, tablets, cameras, PDA's). The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware or hardware in combination with software (e.g., threads, processes, computing devices). The servers 1104 can house threads to perform transformations of media items by employing aspects of this disclosure, for example. One possible communication between a client 1102 and a server 1104 can be in the form of a data packet adapted to be transmitted between two or more computer processes wherein data packets may include coded analyzed headspaces and/or input. The data packet can include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104. Further, the client(s) 1102 can be operatively connected to one or more server data store(s) 1110.

In one exemplary implementation, a client 1102 can transfer an encoded file, (e.g., encoded media item), to server 1104. Server 1104 can store the file, decode the file, or transmit the file to another client 1102. It is noted that a client 1102 can also transfer uncompressed files to a server 1104 and server 1104 can compress the file and/or transform the file in accordance with this disclosure. Likewise, server 1104 can encode information and transmit the information via communication framework 1106 to one or more clients 1102.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or. ” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group”as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:
1. A vehicle, comprising: a processor that executes the computer executable components stored in memory, wherein the computer executable components comprise: a contact zone component that generates a contact zone surrounding the vehicle wherein the contact zone comprises an area outside the vehicle when doors of the vehicle are fully extended; an object monitoring component that identifies a moving object not within the contract zone that is moving towards the contact zone; and a control component that determines a point in time when the moving object will enter the contact zone, and limits opening of a vehicle door to reduce size of the contact zone to mitigate collision between the vehicle door and the moving object.
2. The vehicle of any preceding clause,, wherein the control component determines a proximate location of the moving object within the contact zone and creates a contact free zone wherein the opening of the vehicle door will not collide with the moving object.
3. The vehicle of any preceding clause, wherein the control component determines proximate location of the moving object within the contact zone and restricts opening of the door to avoid collision with moving object.
4. The vehicle of any preceding clause, wherein the control component provides an increasing resistance force to the vehicle door to prevent further opening of the vehicle door to avoid collision if the occupant continues to open the vehicle door during the presence of an object.
5. The vehicle of any preceding clause, wherein the control component determines a proximate location of the moving object within the contact zone and creates a contact free zone wherein the opening of the vehicle door will not collide and provides resistance to the door if occupant attempts to open the door beyond the contact free zone.
6. The vehicle of any preceding clause, wherein the computer executable components further comprise: a sensor system that provides sensory data to the contact zone component to assist in generating the contract zone, wherein the sensor system comprises one or more cameras and proximity sensors positioned around the vehicle to detect presence of objects in the contact zone.
7. The vehicle of any preceding clause, wherein the computer executable components further comprise: an alert component that provides an alert to an occupant attempting to open the vehicle door when determined that the moving object will enter the contact zone created by the opening the door.
8. The vehicle of any preceding clause, further comprising an alert component that provides an external alert by activating headlights, taillights, and a horn if determined that the moving object will enter the contact zone.

In various cases, any suitable combination or combinations of clauses 1-10 can be implemented.
9. A method for controlling an enclosure of a vehicle, comprising: generating, by a system of the vehicle comprising a processor based on sensory data captured of an external environment of the enclosure via one or more sensors integrated on or within the vehicle, a contact zone surrounding the vehicle wherein the contact zone created outside the vehicle when doors of the vehicle are fully extended; identifying, by the system, a moving object not within the contract zone that is moving towards the contact zone; and determining, by the system, a proximate location of the moving object within the contact zone and creating a contact free zone wherein the opening of the vehicle door will not collide with the moving object.
10. The method of any preceding clause, further comprising: determining, by the system, a point in time when the moving object will enter the contact zone and limiting opening of the vehicle door to reduce size of the contact zone to avoid collision; and restricting, by the system, opening of the door to avoid collision if the moving object is within the contact zone and restricts opening of the door of the vehicle.
11. The method of any preceding clause, further comprising: generating, by the system, an increasing resistance force to the vehicle door to prevent further opening of the door to avoid collision if the occupant continues to open the door during the presence of an object.
12. The method of any preceding clause, further comprising: generating, by the system, sensory data used to generate the contract zone using a sensor system, wherein the sensor system comprises one or more cameras and proximity sensors positioned around the vehicle to detect the presence of objects in the contact zone.
13. The method of any preceding clause, further comprising: activating, by the system, an alert to an occupant attempting to open the vehicle door when determined that the moving object will enter the contact zone created by the opening the door.
14. The method of any preceding clause, further comprising: providing an external alert by activating headlights, taillights, and the horn if determined that moving object will enter the contact zone.

In various cases, any suitable combination or combinations of clauses 11-14 can be implemented.
15. A non-transitory machine-readable medium, comprising executable instructions that, when executed by a processor, facilitate performance of operations, comprising: generating a contact zone surrounding the vehicle wherein the contact zone created outside the vehicle when doors of the vehicle are fully extended; identifying a moving object not within the contract zone that is moving towards the contact zone; and determining proximate location of the moving object within the contact zone and creating a contact free zone wherein the opening of the vehicle door will not collide with the moving object.
16. The non-transitory machine-readable medium of any preceding clause, further comprising: determining a point in time when the moving object will enter the contact zone and limits the opening of the vehicle door to reduce size of the contact zone to avoid collision.
17. The non-transitory machine-readable medium of any preceding clause, further comprising: restricting, by the system, opening of the door to avoid collision if the moving object is within the contact zone and restricts opening of the door of the vehicle.
18. The non-transitory machine-readable medium of any preceding clause, further comprising: generating an increasing resistance force to the vehicle door to prevent further opening to avoid collision if the occupant continues to open the door during the presence of an object.
19. The non-transitory machine-readable medium of any preceding clause, further comprising: generating sensory data used to generate the contract zone using a sensor system, wherein the sensor system comprises one or more cameras and proximity sensors positioned around the vehicle to detect the presence of objects in the contact zone.
20. The non-transitory machine-readable medium of any preceding clause, further comprising: activating an alert to an occupant attempting to open the vehicle door when determined that the moving object will enter the contact zone created by the opening the door.

In various cases, any suitable combination or combinations of clauses 15-20 can be implemented.

In various cases, any suitable combination or combinations of clauses 1-20 can be implemented.

What is claimed is:

1. A vehicle, comprising:
a processor that executes the computer executable components stored in memory, wherein the computer executable components comprise:
a contact zone component that generates a contact zone surrounding the vehicle wherein the contact zone comprises an area outside the vehicle when doors of the vehicle are fully extended;
an object monitoring component that identifies a moving object not within the contract zone that is moving towards the contact zone; and
a control component that determines a point in time when the moving object will enter the contact zone, and limits opening of a vehicle door to reduce size of the contact zone to mitigate collision between the vehicle door and the moving object.

2. The vehicle of claim 1, wherein the control component determines a proximate location of the moving object within the contact zone and creates a contact free zone wherein the opening of the vehicle door will not collide with the moving object.

3. The vehicle of claim 1, wherein the control component determines proximate location of the moving object within the contact zone and restricts opening of the door to avoid collision with moving object.

4. The vehicle of claim 1, wherein the control component provides an increasing resistance force to the vehicle door to prevent further opening of the vehicle door to avoid collision if the occupant continues to open the vehicle door during the presence of an object.

5. The vehicle of claim 1, wherein the control component determines a proximate location of the moving object within the contact zone and creates a contact free zone wherein the opening of the vehicle door will not collide and provides resistance to the door if occupant attempts to open the door beyond the contact free zone.

6. The vehicle of claim 1, wherein the computer executable components further comprise:
a sensor system that provides sensory data to the contact zone component to assist in generating the contract zone, wherein the sensor system comprises one or more cameras and proximity sensors positioned around the vehicle to detect presence of objects in the contact zone.

7. The vehicle of claim 1, wherein the computer executable components further comprise:
an alert component that provides an alert to an occupant attempting to open the vehicle door when determined that the moving object will enter the contact zone created by the opening the door.

8. The vehicle of claim 1, further comprising an alert component that provides an external alert by activating headlights, taillights, and a horn if determined that the moving object will enter the contact zone.

9. A method for controlling an enclosure of a vehicle, comprising:
generating, by a system of the vehicle comprising a processor based on sensory data captured of an external environment of the enclosure via one or more sensors integrated on or within the vehicle, a contact zone surrounding the vehicle wherein the contact zone created outside the vehicle when doors of the vehicle are fully extended;
identifying, by the system, a moving object not within the contract zone that is moving towards the contact zone; and
determining, by the system, a proximate location of the moving object within the contact zone and creating a contact free zone wherein the opening of the vehicle door will not collide with the moving object.

10. The method of claim 9, further comprising:
determining, by the system, a point in time when the moving object will enter the contact zone and limiting opening of the vehicle door to reduce size of the contact zone to avoid collision; and
restricting, by the system, opening of the door to avoid collision if the moving object is within the contact zone and restricts opening of the door of the vehicle.

11. The method of claim 10, further comprising:
generating, by the system, an increasing resistance force to the vehicle door to prevent further opening of the door to avoid collision if the occupant continues to open the door during the presence of an object.

12. The method of claim 9, further comprising:
generating, by the system, sensory data used to generate the contract zone using a sensor system, wherein the sensor system comprises one or more cameras and proximity sensors positioned around the vehicle to detect the presence of objects in the contact zone.

13. The method of claim 9, further comprising:
activating, by the system, an alert to an occupant attempting to open the vehicle door when determined that the moving object will enter the contact zone created by the opening the door.

14. The method of claim 13, further comprising:
providing an external alert by activating headlights, taillights, and the horn if determined that moving object will enter the contact zone.

15. A non-transitory machine-readable medium, comprising executable instructions that, when executed by a processor, facilitate performance of operations, comprising:
generating a contact zone surrounding the vehicle wherein the contact zone created outside the vehicle when doors of the vehicle are fully extended;
identifying a moving object not within the contract zone that is moving towards the contact zone; and
determining proximate location of the moving object within the contact zone and creating a contact free zone wherein the opening of the vehicle door will not collide with the moving object.

16. The non-transitory machine-readable medium of claim 15, further comprising:
determining a point in time when the moving object will enter the contact zone and limits the opening of the vehicle door to reduce size of the contact zone to avoid collision.

17. The non-transitory machine-readable medium of claim 16, further comprising:
restricting, by the system, opening of the door to avoid collision if the moving object is within the contact zone and restricts opening of the door of the vehicle.

18. The non-transitory machine-readable medium of claim 15, further comprising:
generating an increasing resistance force to the vehicle door to prevent further opening to avoid collision if the occupant continues to open the door during the presence of an object.

19. The non-transitory machine-readable medium of claim 15, further comprising:
generating sensory data used to generate the contract zone using a sensor system, wherein the sensor system comprises one or more cameras and proximity sensors positioned around the vehicle to detect the presence of objects in the contact zone.

20. The non-transitory machine-readable medium of claim 15, further comprising:
activating an alert to an occupant attempting to open the vehicle door when determined that the moving object will enter the contact zone created by the opening the door.
